(19) United States
(12) Patent Application Publication
(10) Pub. No.: US 2023/0072190 A1
(43) Pub. Date: Mar. 9, 2023

(54) IMPROVING ENERGY EFFICIENCY OF HUMAN-INHABITABLE ENVIRONMENTS

(71) Applicant: Trinity Power and Renewable Resources, Oklahoma City, OK (US)

(72) Inventor: Kevin Spaeth, Oklahoma City, OK (US)

(21) Appl. No.: 17/929,562

(22) Filed: Sep. 2, 2022

Related U.S. Application Data
(60) Provisional application No. 63/269,019, filed on Mar. 8, 2022.
(60) Provisional application No. 63/240,797, filed on Sep. 3, 2021.

(51) Int. Cl. F24F 11/63; F24F 11/46; F24F 11/50; F24F 11/39; F24F 11/38; G05B 19/042; H02M 1/12; H02J 7/00; H02M 1/42

(52) U.S. Cl. CPC F24F 11/63; F24F 11/46; F24F 11/50; F24F 11/39; F24F 11/38; G05B 19/042; H02M 1/12; H02J 7/00712; H02M 1/42; F24F 2130/20

(57) ABSTRACT

A power management system includes a power conditioner configured to condition and perform power factor correction on the electrical power supplied to the main circuit; an inverter, configured to receive direct current (DC) electrical power from a renewable source, and supply alternating current (AC) power to a main circuit that supplies power to an air conditioning system; and a controller configured to profile, using a power profiling meter, electrical power supplied to the main circuit; and modify operations of the air conditioning system or a battery management system based on the profiled electrical power available.

### CROSS-REFERENCE TO RELATED APPLICATIONS

This application claims priority under 35 U.S.C. § 119 to U.S. Provisional Patent Application No. 63/240,797, filed on Sep. 3, 2021, and U.S. Provisional Patent Application No. 63/269,019, filed on Mar. 8, 2022. The entire contents of both previous applications are incorporated by reference herein.

### TECHNICAL FIELD

This disclosure relates to apparatus, systems, and methods for improving energy efficiency of human-inhabitable environments.

### BACKGROUND

Air conditioning systems often make up a significant portion of the electrical power consumed in a building. To offset the costs of generating and transporting electricity, local power generation can be employed to assist in fulfilling a building's electrical requirements.

In addition, human-inhabitable environments, such as single family houses, multi-family houses, and commercial buildings, often require heating and cooling in order to provide a comfortable indoor environment for people and animals, as well as computers and other electronic devices. The addition of heat, or loss of heat, through walls of such structures can may the provision of such heating and cooling more complex and expensive.

### SUMMARY

This disclosure describes apparatus, systems, and methods for improving energy efficiency of human-inhabitable environments.

In an example implementation, a power management system includes a power conditioner configured to condition and perform power factor correction on the electrical power supplied to the main circuit; an inverter, configured to receive direct current (DC) electrical power from a renewable source, and supply alternating current (AC) power to a main circuit that supplies power to an air conditioning system; and a controller configured to perform operations including profiling, using a power profiling meter, electrical power supplied to the main circuit; and modifying operations of the air conditioning system or a battery management system based on the profiled electrical power available.

In an aspect combinable with the example implementation, the operation of profiling the electrical power includes detecting voltage, amperage, wattage, total harmonic distortion, electromagnetic interference (EMI), and electromagnetic field (EMF) losses over time.

In another aspect combinable with any of the previous aspects, the power conditioner filters total harmonic distortion, and applies a variable power factor correction based on sensed apparent power in the main circuit.

In another aspect combinable with any of the previous aspects, the operation of modifying operations of the air conditioning system includes one or more of: activating or deactivating a compressor of the air conditioning system, activating or reactivating one or more economizers of the air conditioning system, adjusting a speed of the compressor, adjusting a thermostat set point, or adjusting an output temperature set point of the air conditioning system.

In another aspect combinable with any of the previous aspects, the operation of profiling the electrical power includes logging time series data of voltage, frequency, amperage, real power consumption, apparent power, power factor (PF), and total harmonic distortion (THD).

In another aspect combinable with any of the previous aspects, the renewable source includes at least one of a photovoltaic panel or a wind turbine.

In another example implementation, a method for managing power includes conditioning, with a power conditioner, electrical power supplied to a main circuit supplying power to an air conditioning system, the conditioning including performing a power factor correction; receiving, from an inverter, alternating current (AC) power to the main circuit, the AC power having been converted by the inverter form direct current (DC) power that was generated by a renewable source; profiling, using a power profiling meter, the electrical power supplied to the main circuit; and modifying, based on the profiled electrical power, operations of the air conditioning system or a battery management system associated with the main circuit.

In an aspect combinable with the example implementation, profiling the electrical power includes detecting voltage, amperage, wattage, total harmonic distortion, electromagnetic interference (EMI), and electromagnetic field (EMF) losses over time.

In another aspect combinable with any of the previous aspects, conditioning the electrical power includes filtering total harmonic distortion, and applying a variable power factor correction based on sensed apparent power in the main circuit.

In another aspect combinable with any of the previous aspects, modifying operations of the air conditioning system includes one or more of: activating or deactivating a compressor of the air conditioning system, activating or deactivating one or more economizers of the air conditioning system, adjusting a speed of the compressor, adjusting a thermostat set point; or adjusting an output temperature set point of the air conditioning system.

In another aspect combinable with any of the previous aspects, profiling the electrical power includes logging time series data of voltage, frequency, amperage, real power consumption, apparent power, power factor (PF), and total harmonic distortion (THD).

In another aspect combinable with any of the previous aspects, the renewable source includes at least one of a photovoltaic panel or a wind turbine.

In another example implementation, an apparatus includes a non-transitory, computer readable storage medium that stores instruction that, when executed by at least one processor, cause the at least one processor to perform operations including conditioning, with a power conditioner, electrical power supplied to a main circuit supplying power to an air conditioning system, the conditioning including performing a power factor correction; receiving, from an inverter, alternating current (AC) power to the main circuit, the AC power having been converted by the inverter form direct current (DC) power that was generated by a renewable source; profiling, using a power profiling meter, the electrical power supplied to the main circuit; and modifying, based on the profiled electrical power, operations of the air conditioning system or a battery management system associated with the main circuit.

In an aspect combinable with the example implementation, the operation of profiling the electrical power includes detecting voltage, amperage, wattage, total harmonic distortion, electromagnetic interference (EMI), and electromagnetic field (EMF) losses over time.

In another aspect combinable with any of the previous aspects, conditioning the electrical power includes filtering total harmonic distortion; and applying a variable power factor correction based on sensed apparent power in the main circuit.

In another aspect combinable with any of the previous aspects, the operation of modifying operations of the air conditioning system includes one or more of: activating or deactivating a compressor of the air conditioning system, activating or deactivating one or more economizers of the air conditioning system, adjusting a speed of the compressor, adjusting a thermostat set point, or adjusting an output temperature set point of the air conditioning system.

In another aspect combinable with any of the previous aspects, the operation of profiling the electrical power includes logging time series data of voltage, frequency, amperage, real power consumption, apparent power, power factor (PF), and total harmonic distortion (THD).

In another aspect combinable with any of the previous aspects, the renewable source includes at least one of a photovoltaic panel or a wind turbine.

In another example implementation, an air conditioning system includes an irradiance sensor configured to detect an ambient solar irradiance; a renewable meter configured to detect a power amount generated by a renewable source; an inverter meter configured to detect a power output of an inverter associated with the renewable source; an array of air conditioning sensors configured to detect a differential pressure across a fan associated with the air conditioner, an ambient humidity, an ambient temperature, a supply humidity, a supply temperature, a return humidity, a return temperature, and a power consumption associated with the air conditioner; and a controller configured to determine a plurality of parameters that include a supply enthalpy based on the supply humidity and supply temperature, a return enthalpy based on the return humidity and return temperature, an ambient enthalpy based on the ambient humidity and ambient temperature, an airflow rate based on the differential pressure across the fan, an inverter efficiency based on the power output of the inverter and the power amount generated by the renewable source, a solar efficiency based on the ambient solar irradiance and the power amount generated by the renewable source, and an air conditioner efficiency based on the airflow rate, the supply enthalpy, and the return enthalpy.

In an aspect combinable with the example implementation, the controller is configured to transmit an alert if a particular parameter of the plurality of parameters falls within a predetermined threshold.

In another aspect combinable with any of the previous aspects, in response to ambient enthalpy being less than return enthalpy the controller sends a signal to activate an economizer in the air conditioner.

In another aspect combinable with any of the previous aspects, in response to air conditioner efficiency falling within the predetermined threshold the alert indicates that a system inspection is required.

In another aspect combinable with any of the previous aspects, in response to the airflow rate falling within the predetermined threshold the alert indicates a filter replacement is required.

In another aspect combinable with any of the previous aspects, in response to the difference between the return enthalpy and the supply enthalpy falling within the predetermined threshold, the alert indicates that a heat exchanger inspection is required.

In another aspect combinable with any of the previous aspects, in response to the solar efficiency falling within the predetermined threshold, the alert indicates a panel inspection is required.

In another aspect combinable with any of the previous aspects, in response to inverter efficiency falling within the predetermined threshold, the alert indicates inverter inspection or replacement is required.

In another example implementation, a method for monitoring an air conditioning system includes detecting, with an irradiance sensor, an ambient solar irradiance, detecting, with a renewable meter, a power amount generated by a renewable source, detecting, with an inverter meter, a power output of an inverter associated with the renewable source, detecting, with an array of air conditioning sensors: a differential pressure across a fan associated with the air conditioner, an ambient humidity, an ambient temperature, a supply humidity, a supply temperature, a return humidity, a return temperature, and a power consumption associated with the air conditioner, and determining, using a controller, a plurality of parameters including a supply enthalpy based on the supply humidity and supply temperature, a return enthalpy based on the return humidity and return temperature, an ambient enthalpy based on the ambient humidity and ambient temperature, an airflow rate based on the differential pressure across the fan, an inverter efficiency based on the power output of the inverter and the power amount generated by the renewable source, a solar efficiency based on the ambient solar irradiance and the power amount generated by the renewable source, and an air conditioner efficiency based on the airflow rate, the supply enthalpy, and the return enthalpy.

An aspect combinable with the example implementation further includes transmitting an alert if a particular parameter of the plurality of parameters falls within a predetermined threshold.

In another aspect combinable with any of the previous aspects, in response to ambient enthalpy being less than return enthalpy the controller sends a signal to activate an economizer in the air conditioner.

In another aspect combinable with any of the previous aspects, in response to air conditioner efficiency falling within the predetermined threshold the alert indicates that a system inspection is required.

In another aspect combinable with any of the previous aspects, in response to the airflow rate falling within the predetermined threshold the alert indicates a filter replacement is required.

In another aspect combinable with any of the previous aspects, in response to the difference between the return enthalpy and the supply enthalpy falling within the predetermined threshold, the alert indicates that a heat exchanger inspection is required.

In another aspect combinable with any of the previous aspects, in response to the solar efficiency falling within the predetermined threshold, the alert indicates a panel inspection is required.

In another aspect combinable with any of the previous aspects, in response to inverter efficiency falling within the predetermined threshold, the alert indicates inverter inspection or replacement is required.

In another example implementation, an apparatus includes a non-transitory, computer readable storage medium that stores instruction that, when executed by at least one processor, cause the at least one processor to perform operations including detecting, with an irradiance sensor, an ambient solar irradiance; detecting, with a renewable meter, a power amount generated by a renewable source; detecting, with an inverter meter, a power output of an inverter associated with the renewable source; detecting, with an array of air conditioning sensors, a differential pressure across a fan associated with the air conditioner, an ambient humidity, an ambient temperature, a supply humidity, a supply temperature, a return humidity, a return temperature, and a power consumption associated with the air conditioner; and determining, using a controller, a plurality of parameters that include a supply enthalpy based on the supply humidity and supply temperature, a return enthalpy based on the return humidity and return temperature, an ambient enthalpy based on the ambient humidity and ambient temperature, an airflow rate based on the differential pressure across the fan, an inverter efficiency based on the power output of the inverter and the power amount generated by the renewable source, a solar efficiency based on the ambient solar irradiance and the power amount generated by the renewable source, and an air conditioner efficiency based on the airflow rate, the supply enthalpy, and the return enthalpy.

An aspect combinable with the example implementation further includes the operation of transmitting an alert if a particular parameter of the plurality of parameters falls within a predetermined threshold.

In another aspect combinable with any of the previous aspects, in response to ambient enthalpy being less than return enthalpy the controller sends a signal to activate an economizer in the air conditioner.

In another aspect combinable with any of the previous aspects, in response to air conditioner efficiency falling within the predetermined threshold, the alert indicates that a system inspection is required.

In another aspect combinable with any of the previous aspects, in response to the airflow rate falling within the predetermined threshold the alert indicates a filter replacement is required.

In another aspect combinable with any of the previous aspects, in response to the difference between the return enthalpy and the supply enthalpy falling within the predetermined threshold, the alert indicates that a heat exchanger inspection is required.

In another aspect combinable with any of the previous aspects, in response to the solar efficiency falling within the predetermined threshold, the alert indicates a panel inspection is required.

In another aspect combinable with any of the previous aspects, in response to inverter efficiency falling within the predetermined threshold, the alert indicates inverter inspection or replacement is required

In another example implementation, a wall system includes a core portion formed from a hardenable material; a conduit section installed within the core portion; a heat transfer surface installed on a first side of the core portion; and at least one insulation layer installed on a second side of the core portion opposite the first side. The conduit section is configured to fluidly couple to at least one fluid conditioning system that is configured to provide a first fluid to the conduit section at a first temperature, and a second fluid to the conduit section at a second temperature different than the first temperature.

In an aspect combinable with the example implementation, a surface area of the heat transfer surface is greater than a surface area of the first side of the core portion to which the heat transfer surface is installed.

In another aspect combinable with any of the previous aspects, the heat transfer surface includes a corrugated surface.

In another aspect combinable with any of the previous aspects, the corrugated surface is formed into and integral with a portion of the hardenable material that forms the first side of the core portion.

In another aspect combinable with any of the previous aspects, the corrugated surface includes a corrugated sheet fastened to the first side of the core portion.

In another aspect combinable with any of the previous aspects, the hardenable material includes a cementitious material.

Another aspect combinable with any of the previous aspects further includes one or more thermal sensors installed on the heat transfer surface.

In another aspect combinable with any of the previous aspects, the one or more thermal sensors is installed on a first side of the heat transfer surface opposite a second side of the heat transfer surface that is in contacting engagement with the first die of the core portion.

In another aspect combinable with any of the previous aspects, the one or more thermal sensors includes one or more dew point sensors.

Another aspect combinable with any of the previous aspects further includes one or more structural supports installed within the hardenable material of the core portion.

In another aspect combinable with any of the previous aspects, the one or more structural supports include one or more rebar sections.

In another aspect combinable with any of the previous aspects, the hardenable material includes a plurality of heat transfer pieces.

In another aspect combinable with any of the previous aspects, the plurality of heat transfer pieces include thermally conductive polymers, shavings, or compounds.

In another aspect combinable with any of the previous aspects, the at least one insulation layer includes a first insulation layer coupled to the second side of the core portion; and a second insulation layer coupled to the first insulation layer.

In another aspect combinable with any of the previous aspects, the first insulation layer includes a foil lined closed cell Styrofoam insulation layer.

In another aspect combinable with any of the previous aspects, the second insulation layer includes a smart shield insulation layer.

Another aspect combinable with any of the previous aspects further includes a layer of electromagnetic field (EMF) shielding paint applied to the second side of the core portion.

Another aspect combinable with any of the previous aspects further includes a Faraday fabric shield layer applied to the second side of the core portion.

Another aspect combinable with any of the previous aspects further includes an external finish layer applied to the second side of the core portion.

Another aspect combinable with any of the previous aspects further includes at least one virtual window system installed in or adjacent the core portion.

In another aspect combinable with any of the previous aspects, the at least one virtual window system includes a camera system configured to capture one or more images of an ambient environment from the second side of the core portion; and a display communicably coupled to the camera system and configured to show the captured one or more images to a human-occupiable indoor environment from the first side of the core portion.

In another aspect combinable with any of the previous aspects, the conduit section includes a serpentine conduit section.

Another example implementation includes a method for manufacturing a wall system according to any of the previous aspects. For example, the method for manufacturing the wall system can include: forming a core portion from a hardenable material; installing a conduit section within the core portion; installing a heat transfer surface on a first side of the core portion; and installing at least one insulation layer on a second side of the core portion opposite the first side. The conduit section is configured to fluidly couple to at least one fluid conditioning system that is configured to provide a first fluid to the conduit section at a first temperature, and a second fluid to the conduit section at a second temperature different than the first temperature. Another example implementation includes a method for operating the manufactured wall system as part of a human-inhabitable environment.

In another example implementation, a human-occupiable environment includes an exterior wall system that includes a plurality of sections of a wall system and a roof system coupled to the plurality of sections of the wall system to define a human-occupiable interior volume. At least one of the plurality of sections of the wall system includes a core portion formed from a hardenable material, a conduit section installed within the core portion, a heat transfer surface installed on a first side of the core portion that faces the human-occupiable interior volume, and at least one insulation layer installed on a second side of the core portion opposite the first side The human-occupiable environment also includes a heat pump system that includes a first heat exchanger coil fluidly coupled to the conduit section to provide a first fluid to the conduit section at a first temperature, a second heat exchanger coil fluidly coupled to the conduit section to provide a second fluid to the conduit section at a second temperature different than the first temperature, and at least one compressor configured to adjust at least a pressure of a working fluid that circulates through the first and second heat exchanger coils.

In an aspect combinable with the example implementation, a surface area of the heat transfer surface is greater than a surface area of the first side of the core portion to which the heat transfer surface is installed.

In another aspect combinable with any of the previous aspects, the heat transfer surface includes a corrugated surface.

In another aspect combinable with any of the previous aspects, the corrugated surface is formed into and integral with a portion of the hardenable material that forms the first side of the core portion.

In another aspect combinable with any of the previous aspects, the corrugated surface includes a corrugated sheet fastened to the first side of the core portion.

In another aspect combinable with any of the previous aspects, the hardenable material includes a cementitious material.

In another aspect combinable with any of the previous aspects, the at least one section of the wall system further includes one or more thermal sensors installed on the heat transfer surface.

In another aspect combinable with any of the previous aspects, the one or more thermal sensors is installed on a first side of the heat transfer surface opposite a second side of the heat transfer surface that is in contacting engagement with the first die of the core portion.

In another aspect combinable with any of the previous aspects, the one or more thermal sensors includes one or more dew point sensors.

In another aspect combinable with any of the previous aspects, the at least one section of the wall system further includes one or more structural supports installed within the hardenable material of the core portion.

In another aspect combinable with any of the previous aspects, the one or more structural supports include one or more rebar sections.

In another aspect combinable with any of the previous aspects, the hardenable material includes a plurality of heat transfer pieces.

In another aspect combinable with any of the previous aspects, the plurality of heat transfer pieces include thermally conductive polymers, shavings, or compounds.

In another aspect combinable with any of the previous aspects, the at least one insulation layer includes a first insulation layer coupled to the second side of the core portion; and a second insulation layer coupled to the first insulation layer.

In another aspect combinable with any of the previous aspects, the first insulation layer includes a foil lined closed cell Styrofoam insulation layer.

In another aspect combinable with any of the previous aspects, the second insulation layer includes a smart shield insulation layer.

In another aspect combinable with any of the previous aspects, the at least one section of the wall system further includes a layer of electromagnetic field (EMF) shielding paint applied to the second side of the core portion.

In another aspect combinable with any of the previous aspects, the at least one section of the wall system further includes a Faraday fabric shield layer applied to the second side of the core portion.

In another aspect combinable with any of the previous aspects, the at least one section of the wall system further includes an external finish layer applied to the second side of the core portion.

In another aspect combinable with any of the previous aspects, the at least one section of the wall system further includes at least one virtual window system installed in or adjacent the core portion.

In another aspect combinable with any of the previous aspects, the at least one virtual window system includes a camera system configured to capture one or more images of an ambient environment from the second side of the core portion; and a display communicably coupled to the camera system and configured to show the captured one or more images to the human-occupiable interior volume from the first side of the core portion.

In another aspect combinable with any of the previous aspects, the first conduit section includes a first serpentine conduit section, and the second conduit section includes a second serpentine conduit section.

In another aspect combinable with any of the previous aspects, the first heat exchanger coil includes an evaporator coil configured to transfer heat from the first fluid to the working fluid to cool the first fluid, and the second heat exchanger coil includes a condenser coil configured to transfer heat to the second fluid from the working fluid to heat the second fluid.

Another aspect combinable with any of the previous aspects further includes a first fluid tank fluidly coupled between the first conduit section and the evaporator coil and configured to store an amount of the first fluid at or near the first temperature.

Another aspect combinable with any of the previous aspects further includes a second fluid tank fluidly coupled between the second conduit section and the condenser coil and configured to store an amount of the second fluid at or near the second temperature.

Another aspect combinable with any of the previous aspects further includes a first piping system fluidly coupled between the first fluid tank and the first conduit section.

In another aspect combinable with any of the previous aspects, the first piping system includes a supply conduit fluidly coupled between the first fluid tank and an inlet of the first conduit section, a return conduit fluidly coupled between the first fluid tank and an outlet of the first conduit section, and at least one pump configured to circulate the first fluid from the first fluid tank, through the supply conduit, and to the first conduit section.

Another aspect combinable with any of the previous aspects further includes a second piping system fluidly coupled between the second fluid tank and the second conduit section.

In another aspect combinable with any of the previous aspects, the second piping system includes a supply conduit fluidly coupled between the second fluid tank and an inlet of the second conduit section, a return conduit fluidly coupled between the second fluid tank and an outlet of the second conduit section, and at least one pump configured to circulate the second fluid from the second fluid tank, through the supply conduit, and to the second conduit section.

Another aspect combinable with any of the previous aspects further includes a first geothermal conduit loop fluidly coupled to the first fluid tank and configured to extend from a terranean surface into conductive heat exchange contact with at least one subterranean formation; and a second geothermal conduit loop fluidly coupled to the second fluid tank and configured to extend from the terranean surface into conductive heat exchange contact with the at least one subterranean formation.

Another aspect combinable with any of the previous aspects further includes at least one outdoor air conditioning system including at least one fan configured to circulate a flow of outdoor air from an ambient environment into the human-occupiable interior volume.

In another aspect combinable with any of the previous aspects, the at least one outdoor air conditioning system further includes at least one liquid-to-air heat exchanger that is configured to receive at least one of the first or second fluids to adjust a temperature or humidity of the flow of outdoor air.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example combined air conditioning and power generation system.

FIG. 2 illustrates an example validator system for a combined air conditioning and power generation system.

FIG. 3 is a flowchart describing an example method for controlling an air conditioning and power generation system.

FIG. 4 is a flowchart describing an example method for validating an air conditioning and power generation system.

FIG. 5A is a schematic illustration of a portion of an example implementation of a wall system according to the present disclosure.

FIG. 5B is a schematic illustration of a section of an example implementation of a wall system according to the present disclosure.

FIG. 5C shows schematic illustrations of example implementations of forms that can be used to construct a core portion of a wall system according to the present disclosure.

FIG. 6 is a schematic illustration of a human-occupiable environment according to the present disclosure.

FIG. 7 is a schematic illustration of an example implementation of a portion of a thermal fluid conditioning system for a wall system according to the present disclosure.

FIG. 8 is a schematic illustration of an example implementation of another portion of a thermal fluid conditioning system for a wall system according to the present disclosure.

FIG. 9 is a schematic illustration of an example control system according to the present disclosure.

### DETAILED DESCRIPTION

This disclosure describes a system for combining air conditioning and local power generation to improve the power efficiency of a building. In many facilities, air conditioning accounts for the single largest electrical consumer in the building. A system allows for control of local power generation can optimize operation of both the local power generation and the air conditioning system to provide an improvement in overall system efficiency, and therefore a reduction in energy consumption for the building as a whole.

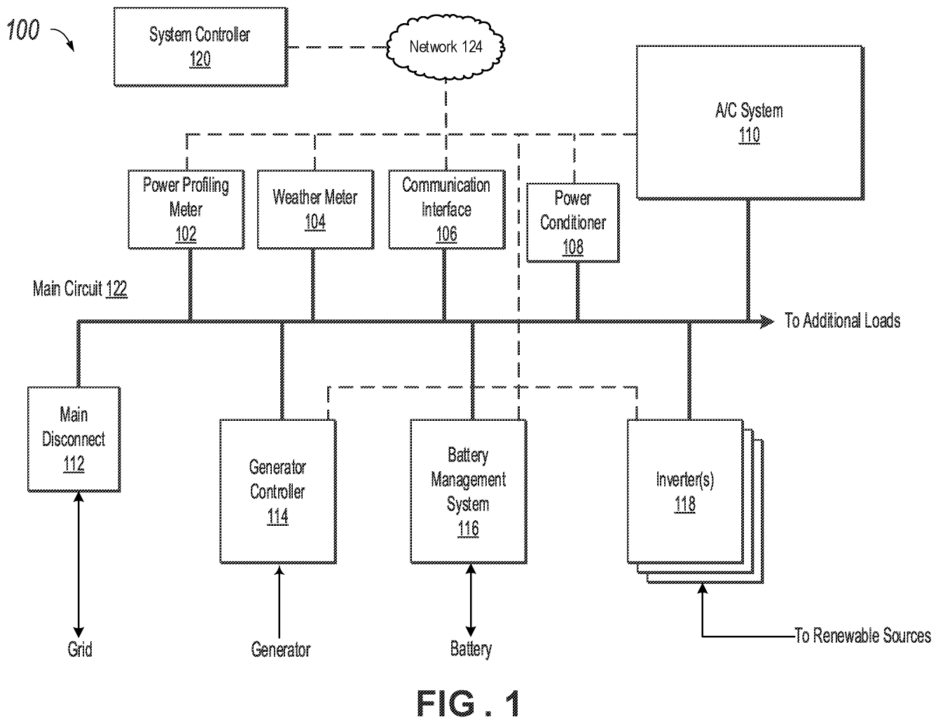

FIG. 1 illustrates an example combined air conditioning and power generation system 100. The system 100 includes one or more power profiling meters 102, a weather meter 104, a communication interface 106, one or more power conditioners 108, one or more air conditioning (A/C) system 110, a main disconnect 112, a generator controller 114, one or more battery management system 116, and one or more inverters 118 converting direct current (DC) electricity from renewable sources to alternating current (AC) electricity. Most of these elements can be monitored or operated by a system controller 120 system which is a controller executing software in the overall operation of system 100.

The power profiling meter 102 detects and records power in the main circuit 122 to generate a profile of the power. While illustrated as a single line, it should be noted that the main circuit 122 can be a three (or more) phase, multi-line power circuit. Power profiling meter 102 records fundamental electrical parameters such as voltage, amperage, frequency, real power consumption, apparent power, power factor (PF), and total harmonic distortion (THD), over time in the main circuit 122. Additionally, the power profiling meter 102 can observe and record load specific parameters for various loads on the main circuit (e.g., real and apparent power consumption, as well as total harmonic distortion observed at the A/C system 110.) In some instances, the power meter reads power bi-directionally, reading power production devices such as renewable energy (e.g., solar panels, wind turbines, etc.). In some implementations the power profiling meter 102 includes one or more communications ports, which can be used to send command signals to various components in the system (e.g., command the battery management system 116 to begin charging the battery) or communicate recorded parameters (e.g., stream monitored data to the system controller 120). Communications ports can include, but are not limited to EIA-485 serial connections, Ethernet, USB, Bluetooth, Wi-Fi, Zigbee, BACnet, Modbus, or other communications methods.

A weather meter 104 can be installed in the system 100 and can provided data associated with the local weather. In some implementations, weather meter 104 communicates with an external network (e.g., the internet) to log and provide weather information. In some implementations, weather meter 104 includes one or more sensors that record parameters associated with the local weather and reports them back to the system controller 120. For example, the weather meter 104 can have sensor that record temperature, humidity, solar irradiance, wind, precipitation, barometric pressure, or other parameters associated with the weather.

A communication interface 106 facilitates communications between the power profiling meter 102, weather meter 104, other component in system 100, and the system controller 120 via network 124, which can be executing on a cloud based system, or at a remote server. Network 124 facilitates wireless or wireline communications between the components of the system 100 (e.g., between the power profiling meter 102, the A/C system 110, or the battery management system 116 etc.), as well as with any other local or remote computers, such as additional mobile devices, clients, servers, or other devices communicably coupled to network 124, including those not illustrated in FIG. 1. In the illustrated environment, the network 124 is depicted as a single network, but can be comprised of more than one network without departing from the scope of this disclosure, so long as at least a portion of the network 124 can facilitate communications between senders and recipients. In some instances, one or more of the illustrated components (e.g., the system controller 120, weather meter 104, etc.) can be included within or deployed to network 124, or a portion thereof, as one or more cloud-based services or operations. The network 124 can be all or a portion of an enterprise or secured network, while in another instance, at least a portion of the network 124 can represent a connection to the Internet. In some instances, a portion of the network 124 can be a virtual private network (VPN). Further, all or a portion of the network 124 can comprise either a wireline or wireless link. Example wireless links can include 802.11a/b/g/n/ac, 802.20, WiMax, LTE, and/or any other appropriate wireless link. In other words, the network 124 encompasses any internal or external network, networks, sub-network, or combination thereof operable to facilitate communications between various computing components inside and outside the illustrated system 100. The network 124 can communicate, for example, Internet Protocol (IP) packets, Frame Relay frames, Asynchronous Transfer Mode (ATM) cells, voice, video, data, and other suitable information between network addresses. The network 124 can also include one or more local area networks (LANs), radio access networks (RANs), metropolitan area networks (MANs), wide area networks (WANs), all or a portion of the Internet, and/or any other communication system or systems at one or more locations.

A power conditioner 108 provides PF correction, as well as reduces THD and conditions the power on the main circuit 122. In some implementations, the power conditioner 108 provides voltage regulation and surge protection, reducing or eliminating unwanted voltage spikes (or dips) in the main circuit 122. The power conditioner 108 can also provide real time AC phase correction and filtration of harmonic signals in the main circuit 122 which may be introduced by digital power electronics such as inverters 118, or other components of system 100.

The A/C system 110 is a system that removes heat from an interior space (e.g., a building) and rejects it to an exterior space (e.g., to ambient). In some implementations the A/C system 110 can function as a heat pump, and the opposite occurs in heating mode. Generally, A/C system 110 can be any suitable cooling system that uses electricity to power one or more components (e.g., one or more compressors, sensors, actuators, motors, etc.) to move such heat from the interior space to the exterior space. For example, the A/C system 110 can be a vapor-compression refrigeration system, which includes at least one compressor, at least one condenser (or gas cooler), at least one expansion device (such as a thermal expansion valve, or “TXV”), and at least one evaporator that, collectively, define the vapor-compression cycle (and are fluidly connected). In some aspects, the refrigerant is a man-made refrigerant, such as a chlorofluorocarbon (CFC), a hydrochlorofluorocarbon (HCFC), a hydrofluorocarbon (HFC), or a blend of two or more of any of these types of refrigerants.

In some aspects, the A/C system 110 can be a direct expansion (DX) system (e.g., residential or commercial), in which, e.g., a sub-critically compressed refrigerant flows through the evaporator (e.g., cooling coil) to directly cool an airflow. In some aspects, the A/C system 110 can be a heat pump system, which can operate in a “cooling mode” (in which heat taken from the interior space is rejected to the exterior space) or a “heating mode” (in which heat taken from the exterior space is put into the interior space). In some implementations, the A/C system 110 is a split system, with a condenser and compressor located remotely (and together, in some cases, in a “condensing unit”) from the evaporator and fan (combined, for example, in a fan-coil unit or furnace with a filter). In other implementations, the A/C system 110 is a packaged unit, with all major components (e.g., compressor(s), condenser(s), evaporator(s), fan(s), expansion device(s) sharing a common housing. In some implementations, such as large buildings or properties (e.g. campuses), heating and cooling may be provided by a central plant made up of chillers and boilers.

The main disconnect 112 is a breaker which separates the main circuit 122 from an electrical power grid. In some implementations the grid supplies power to the main circuit 122 when there is insufficient power from alternative sources (e.g., generator, battery, or renewables) to maintain main circuit 122. Main disconnect 112 can include one or more circuit breakers, which can feature manual and automatic trips. For example, the main disconnect 112 can have a manual trip and reset lever, as well as a 200 Amp breaker. In some implementations, the main disconnect 112 permits power to flow from the main circuit 122 back to the grid. For example, when generated renewable energy exceeds the demand of the main circuit 122, additional power can be supplied back to the grid, which can be used to service demand at other locations.

A generator controller 114 can control or operate one or more local generators. These can be conventional power generators (e.g., diesel, natural gas, or gasoline powered or hydrogen) which can be used to supply electrical power in the even the grid or other services are unavailable. The generator controller 114 is able to activate, or deactivate local generators, as well as regulate their supplied power. In some implementations, the generator controller 114 receives commands from the system controller 120, the power profiling meter 102, or a utility authority to energize one or more generators in order to supply electrical power to the main circuit 122. Additionally, the generator controller 114, can relay relevant parameters to the system controller 120 or power profiling meter 102 for operation of the local generators. For example the generator controller 114 can transmit fuel remaining, operating temperatures (e.g., oil/lubricant temperature, cylinder head temperature, etc.), revolutions per minute (RPM), current power output, maximum available power output, or other engine parameters.

In some implementations, when demand on the grid is greater than what is available based on power generation of the grid (e.g., local or regional utility companies are providing) the system controller 120 can send a command to the generator controller 114 bringing local power generation online to supply local loads, or even feedback power to the grid. In this manner, the system 100 can assist in supplying peak demands to the grid by either directly supplying from local generation, or reducing the main circuit 122's reliance on the grid to supply local loads. This can reduce the need for the utility supplying the grid to bring online additional power generation, or inefficient “peaker” plants. In some implementations, the user of system 100 can enter into an agreement with the local grid supplier to allow them to request local power generation in order to balance, or reduce overall load on the grid. This reduced load can be advantageous in that it can prevent or reduce rolling blackouts, or periods of time were service is not delivered to the customer.

A battery management system 116 can be installed and supply electrical power to or withdraw power from the main circuit 122 to a battery or other electrical storage system (e.g., hydrogen fuel cell system). The battery management system 116 can control operations of one or more batteries, such as charging, discharging, or other maintenance procedures (e.g., maintenance deep cycles, cell balancing, agitation control of chemical batteries, etc.). Battery management system 116 can additionally record and report various battery related parameters, such as cell temperatures, state of charge, provided power, charge rate, absorption rate, time remaining to minimum capacity, or other parameters. In some implementations the battery management system 116 includes an integrated inverter. In other implementations, the battery management system 116 can control one or more of the inverters 118 which convert DC from batteries to AC to supply the main circuit 122.

One or more inverters 118 can convert DC electrical power supplied by renewable sources to AC electrical power suitable for the main circuit 122. In some implementations the inverters 118 include one or more switching transistors, which can introduce harmonic distortions to the main circuit 122 as they convert DC power to AC power. These harmonic distortions can cause early failure of electrical components, additional power wasted to heat, and electromagnetic field (EMF) energy, which can cause interference and inefficiency. The power conditioner 108 can reduce or eliminate these imperfections caused by the inverters 118. In general, inverters 118 receive DC power from one or more renewable resources, such as photovoltaic panels (e.g., solar panels), wind turbines, hydroelectric, batteries, or other source of DC power.

The system controller 120 receives information on operations of the system 100 and can send commands and signals to the various components (e.g., A/C system 110, inverters 118, battery management system 116, etc.). The system controller 120 can be an enterprise level data center which receives data in real time or near real-time or a local controller that sends information to and receives from an enterprise level data center. Information at the enterprise level data center can be sorted by customer, utility, grid number, and circuit number as provided by the utility. Customers in a micro-grid can be tracked as a separate grid number. In some implementations, where customers that decide to go “off-grid” the data can be collected in a separate file for data collection purposes.

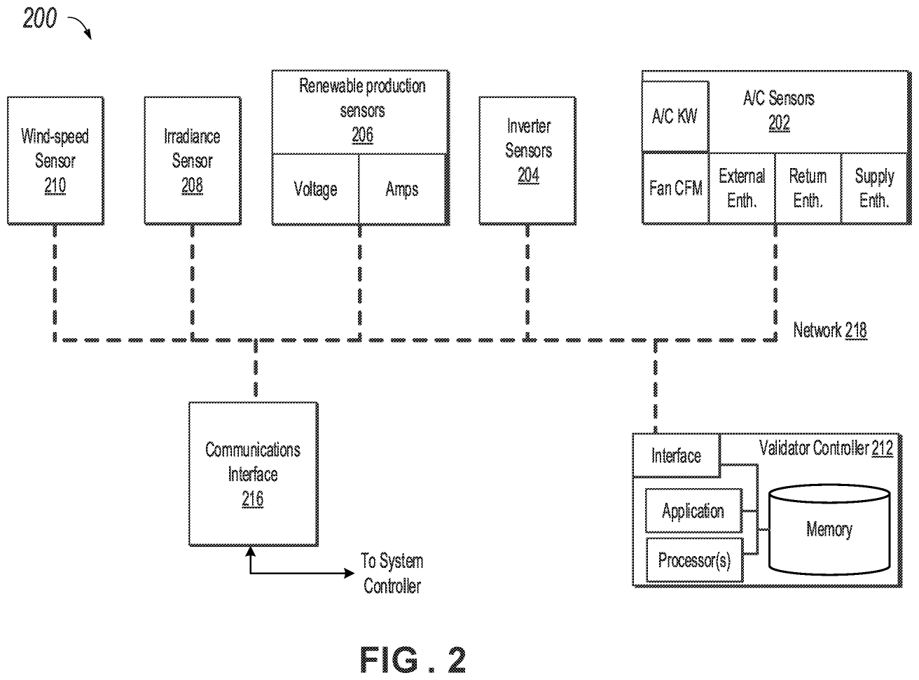

The system controller 120 uses the data collected from the power profiling meter 102, validator (as described below with reference to FIG. 2), and weather meter 104 to provide a fully automated operation of the system 100. In some implementations, the system controller 120 can calculate times when it may be necessary to turn on the generator to offset peak KW or demand KW. In some implementation the system controller 120 will receive generator activation commands from the utility. This will allow the utility to take proactive steps to avoid disruption of service to customers. Instead of having rolling blackouts the system controller 120 can enable self-healing grids. For example, if hypothetical Grid 33 is approaching 75% capacity, it is still only 2:00 PM, the rate of rise calculation indicates the utility will need 107% capacity by 5:45 PM. The utility, via a demand threshold contract with its customers, turns on 63 local generators on Grid 33, Grid 33 coasts through the evening at 95% capacity! This feature can be significantly less expensive for the utility than building a peaking plant or rebuilding a substation due to expansion or undersized infrastructure. In some implementations this solution also gives the utility time to improve its infrastructure.

The system controller 120 can log performance of the renewable sources such as photovoltaics as well. For example, the system controller 120 can record the allocation of energy generated by the solar system used by the facility, stored to the facility batteries, stored to car batteries, or sold back to the grid as regulated by individual utilities.

In certain instances, the system controller 120 receives additional inputs from external sources such as billing information from a utility, lightning surveys, temperature and weather data (e.g., normal, means, and extremes of temperature or precipitation), building code and survey data, among other things.

Additionally, the system controller 120 can log readings from the validator (described below). The system controller 120 can compare readings of renewable production from the power profiling meter 102 and the validator's sensed solar irradiance to determine array efficiency. The system controller 120 can alert customer or dispatch service calls for low or non-performing solar systems. The system controller 120 also records readings from the power meter air conditioning loads and compares them to the BTU readings of the Validator. The System controller 120 can alert customer or dispatch service calls for low or non-performing air conditioning systems.

FIG. 2 illustrates an example validator system 200 for a combined air conditioning and power generation system. The validator system 200 includes multiple sensors and a controller which can independently validate the performance of a combined air conditioning and power generation system (e.g., system 100 of FIG. 1). In some implementations, each sensor in the validator system 200 is distinct and separate from sensors in the combined air conditioning and power generation system it validates. In some implementations, one or more of the sensors in the validator system 200 are shared with the combined air conditioning and power generation system. For example, the validator system 200 can have a separate irradiance sensor 208, but share renewable production sensors 206 with the combined air conditioning and power generation system. The validator system 200 can include, but is not limited to, A/C sensors 202, inverter sensors 204, renewable production sensors 206, irradiance sensors 208, and a wind-speed sensor 210. A validator controller 212 can record sensed values from the various sensors and send commands, alerts, or status updates to various other systems via the communications interface 216.

A/C Sensors 202 can record and transmit various temperatures and humidities, as well as fan parameters. For example A/C sensors 202 can include, but are not limited to an ambient temperature sensor, and ambient humidity sensor, a return air temperature sensor, a return air humidity sensor, a supply air temperature sensor, a supply air humidity sensor, a fan speed sensor, a differential pressure across the fan, an input voltage sensor, and an input current sensor. Data from these sensors can be combined to determine ambient air enthalpy, return air enthalpy, supply air enthalpy, airflow through the A/C system (e.g., in cubic feet per minute (CFM)), A/C power consumption (e.g., in watts), BTU's per hour (BTUH) removed by the A/C system (e.g., BTUH=4.5*FanCFM*(Return Enthalpy-Supply Enthalpy)), and an overall energy efficiency ratio for the A/C system (e.g., BTUH divided by A/C power consumption). In some implementations, the A/C Sensors 202 sense the fundamental parameters (e.g., temperatures, humidities, amperages, voltages, and pressures) and the higher level parameters (e.g., enthalpies, air-flow, and power consumption) are calculated by the validator controller 212.

Inverter sensor 204 can sense voltage and amperage at the output of the inverters (e.g., inverters 118 of FIG. 1) and determine an AC power output associated with the inverters. This can be combined with information from the renewable productions sensors 206 to determine an inverter efficiency. For example, inverter efficiency can be defined as AC power out in watts divided by DC power in, in watts. Renewable production sensors 206 can sense the DC voltage and amperage produced by renewable sources (e.g., wind turbines, or photovoltaic panels). Additional ambient sensors, such as an irradiance sensor 208, or a wind-speed sensor 210 can be detect ambient environmental parameters which can be combined with the sensed output of the renewable sources to determine a renewable efficiency. For example, efficiency of a solar array can be determined as array output power divided by irradiance per square meter. In another example, wind turbine efficiency can be determined as turbine output power divided by wind-speed.

A communication interface 216, which can be similar to or different from communications interface 116 as described with respect to FIG. 1, can provide communications between the validator system 200 and external systems (e.g., combined power generation and air conditioning system 100 of FIG. 1).

The validator controller 212 receives sensed parameters from the various sensors and components of validator system 200, performs necessary calculations and determinations, and analyzes the information to determine operational status of the system it is validating. The validator includes an interface for communications, one or more processors, one or more memories, and a software application executing on the one or more processors.

The interface is used by the validator controller 212 for communicating with other systems in a distributed environment—including within the system 200, or external to the system 200 (e.g. via a network), and other systems communicably coupled to the illustrated validator system 200. Generally, the interface comprises logic encoded in software and/or hardware in a suitable combination and operable to communicate with the network 218 and other components. More specifically, the interface can comprise software supporting one or more communication protocols associated with communications such that the network 218 and/or interface's hardware is operable to communicate physical signals within and outside of the illustrated system 100. Still further, the interface can allow the validator controller 212 to communicate to perform the operations described herein. Further, all or a portion of the network 218 can comprise either a wireline or wireless link. Example wireless links can include 802.11a/b/g/n/ac, 802.20, WiMax, LTE, and/or any other appropriate wireless link. In other words, the network 124 encompasses any internal or external network, networks, sub-network, or combination thereof operable to facilitate communications between various computing components inside and outside the illustrated system 200. The network 218 can communicate, for example, Internet Protocol (IP) packets, Frame Relay frames, Asynchronous Transfer Mode (ATM) cells, voice, video, data, and other suitable information between network addresses. The network 218 can also include one or more local area networks (LANs), radio access networks (RANs), metropolitan area networks (MANs), wide area networks (WANs), all or a portion of the Internet, and/or any other communication system or systems at one or more locations. In some implementations, the network 218 is an RS485 serial network.

The validator controller 212 also includes one or more processors. Although illustrated as a single processor in FIG. 2, multiple processors can be used according to particular needs, desires, or particular implementations of the system 200. Each processor can be a central processing unit (CPU), an application specific integrated circuit (ASIC), a field-programmable gate array (FPGA), or another suitable component. Generally, the processor executes instructions and manipulates data to perform the operations of the validator controller 212. Specifically, the processor executes the algorithms and operations described in the illustrated figures, as well as the various software modules and functionality, including the functionality for sending communications to and receiving transmissions from sensors (e.g., renewable production sensors 206, inverter sensors 204, and A/C sensors 202, etc.), as well as to other devices and systems. Each processor can have a single or multiple core, with each core available to host and execute an individual processing thread. Further, the number of, types of, and particular processors used to execute the operations described herein can be dynamically determined based on a number of requests, interactions, and operations associated with the validator controller 212.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component can be fully or partially written or described in any appropriate computer language including C, C++, JavaScript, Java™, Visual Basic, assembler, Perl®, any suitable version of 4GL, as well as others.

Memory of the validator controller 212 can represent a single memory or multiple memories. The memory can include any memory or database module and can take the form of volatile or non-volatile memory including, without limitation, magnetic media, optical media, random access memory (RAM), read-only memory (ROM), removable media, or any other suitable local or remote memory component. The memory can store various objects or data, including sensor data, historical performance data, administrative settings, password information, caches, applications, backup data, repositories expected performance data and/or dynamic information, and any other appropriate information associated with the validator controller 212, including any parameters, variables, algorithms, instructions, rules, constraints, or references thereto. Additionally, the memory can store any other appropriate data, such as VPN applications, firmware logs and policies, firewall policies, a security or access log, print or other reporting files, as well as others. While illustrated within the validator controller 212, memory or any portion thereof, including some or all of the particular illustrated components, can be located remote from the validator controller 212 in some instances, including as a cloud application or repository, or as a separate cloud application or repository when the validator controller 212 itself is a cloud-based system. In some instances, some or all of memory can be located in, associated with, or available through one or more other systems associated with managing the combined power generation and air conditioning system. In those examples, the data stored in memory can be accessible, for example, via network 218, and can be obtained by particular applications or functionality of the validator controller 212.

The validator controller 212 includes an application which receives sensed parameters from various sensors, performs calculations and analyzes the data to perform validation. In some implementations, the application compares sensed and derived parameters to expected parameters or thresholds and transmits an alert if the parameters fall within (or below) a predetermined threshold. For example, if the validator determines from the A/C sensors 202 that ambient enthalpy is less than the return air enthalpy, the validator can send a command or alert to ensure that economizers associated with the A/C system have been activated. In another example, if the sensed fan CFM is below a predetermined threshold, at alert can be sent indicating a filter inspection is required. The application can assess performance of a system to be validated such as performance of the renewable source, A/C system, inverters, etc. and determine if one or more components are experiencing degraded performance.

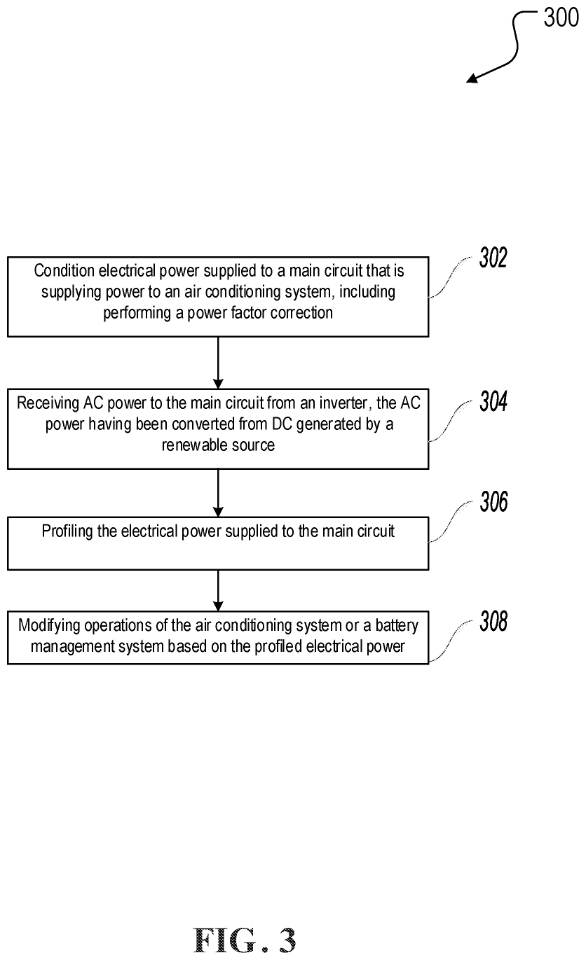

FIG. 3 is a flowchart describing an example method 300 for controlling an air conditioning and power generation system. Method 300 may be performed, for example, by any suitable system, environment, software, and hardware, or a combination of systems, environments, software, and hardware as appropriate. In some instances, method 300 can be performed by the power generation system 100, or portions thereof, described in FIG. 1, as well as other components or functionality described in other portions of this description. In other instances, method 300 may be performed by a plurality of connected components or systems. Any suitable system(s), architecture(s), or application(s) can be used to perform the illustrated operations.

At 302, electrical power supplied to a main circuit that is supplying power to an air conditioning system is conditioned. Conditioning the power includes performing a power factor correction. In some instance, conditioning also includes removal or reduction of total harmonic distortion, voltage regulation and surge protection, reduction or eliminating unwanted voltage spikes (or dips) in the main circuit. In some implementations, power conditioning also includes real time AC phase correction and filtration of harmonic signals in the main circuit which may be introduced by digital power electronics such as inverters, or other components.

At 304, AC power from an inverter is received, the AC power having been converted from DC power that was generated by a renewable source. Renewable sources can include, but are not limited to photovoltaic panels (e.g., solar panels), wind turbines, hydroelectric, or batteries.

At 306, the electrical power on the main circuit, including the received AC power and, in some implementations, power received from an external grid, is profiled. Profiling the power can include generating time series data of voltage, frequency, amperage, real power consumption, apparent power, power factor (PF), and total harmonic distortion (THD).

At 308, operations associated with the air conditioning system or a battery management system are modified, based on the profiled power. Modifying operations can include, but is not limited to, activating or deactivating a compressor of the air conditioning system, activating or deactivating one or more economizers of the air conditioning system, adjusting a compressor speed, adjusting a thermostat set point, and/or adjusting an output temperature set point of the air conditioning system.

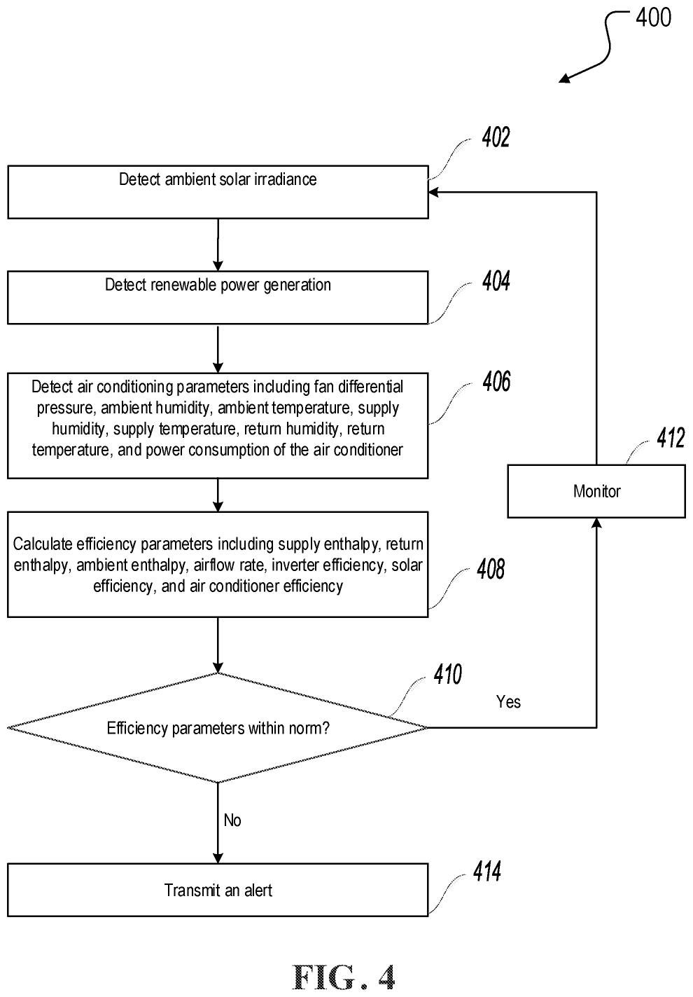

FIG. 4 is a flowchart describing an example method 400 for validating an air conditioning and power generation system. Method 400 may be performed, for example, by any suitable system, environment, software, and hardware, or a combination of systems, environments, software, and hardware as appropriate. In some instances, method 400 can be performed by the validator system 200, or portions thereof, described in FIG. 2, as well as other components or functionality described in other portions of this description. In other instances, method 400 may be performed by a plurality of connected components or systems. Any suitable system(s), architecture(s), or application(s) can be used to perform the illustrated operations.

At 402, ambient solar irradiance is detected. In some implementations, ambient solar irradiance is detected using a single irradiance sensor. In some implementations, an array of sensors are used to detect ambient solar irradiance

At 404, renewable power generation is detected. Renewable power generation can be detected based on an input voltage and current to one or more inverters, or based on one or more output sensors associated with one or more renewable generators.

At 406, air conditioning parameters are determined. In some implementations, these parameters are determined using an array of independent sensors (e.g., A/C sensors 202 as described with respect to FIG. 2). The air conditioning parameters detected can include, but are not limited to fan differential pressure, ambient humidity, ambient temperature, supply humidity, supply temperature, return humidity, return temperature, and/or power consumption of the air conditioner.

At 408, efficiency parameters associated with the system are calculated. These calculations can be made based on the detected air conditioning parameters, as well as the ambient irradiance and renewable power generation. Efficiency parameters can include, but are not limited to, supply enthalpy, return enthalpy, ambient enthalpy, airflow rate, inverter efficiency, solar efficiency, and/or air conditioner efficiency.

At 410, a determination is made whether the efficiency parameters are within specification, or a predetermined threshold. If the parameters are within the predetermined threshold (or normal), method 400 proceeds to 412, where the process repeats. If the efficiency parameters are outside of the predetermined threshold (or abnormal), then method 400 proceeds to 414 where an alert is transmitted.

The alert can include, but is not limited to, an alert indicating a system inspection is required, indicating a filter replacement is required, indicating a heat exchanger inspection is required, indicating a panel inspection is required, and/or indicating an inverter inspection or replacement is required.

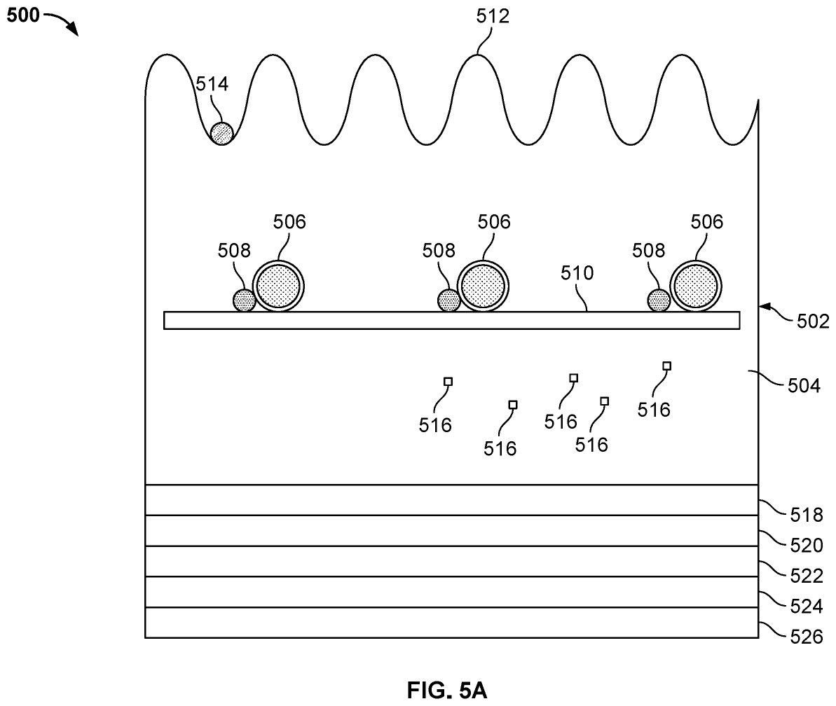

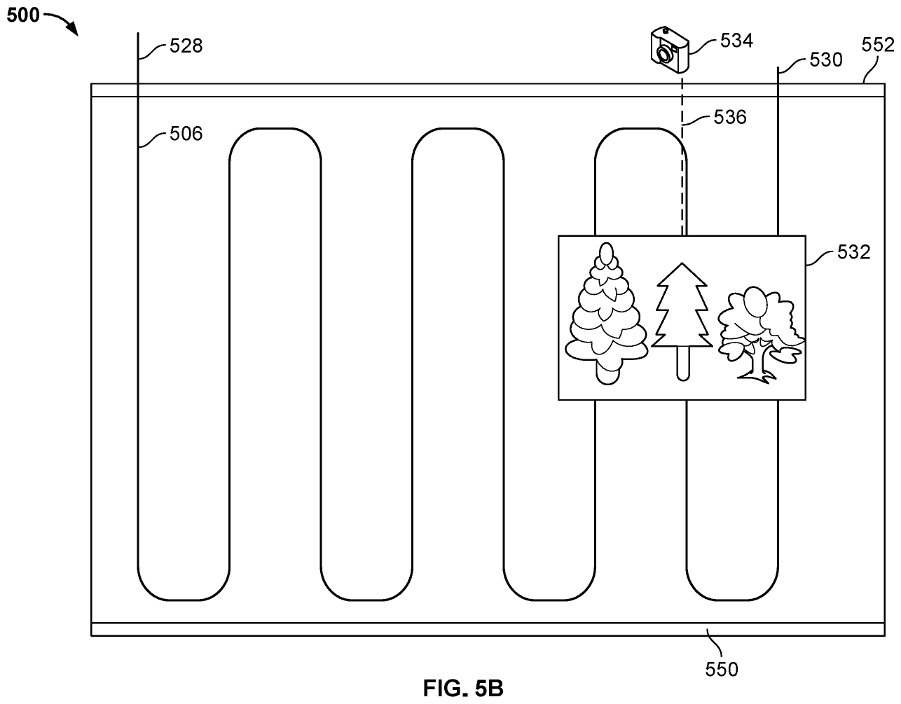

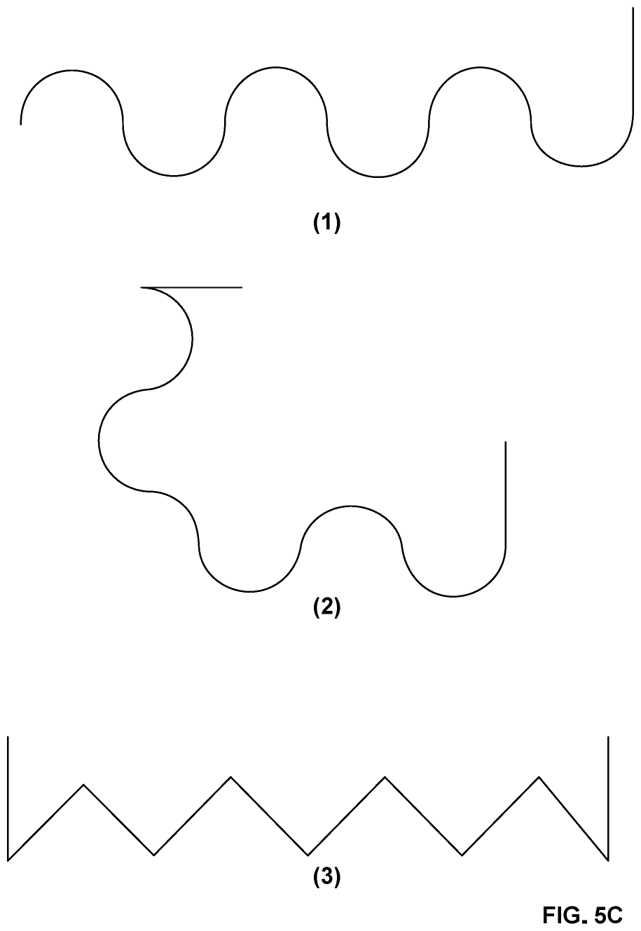

FIG. 5A is a schematic illustration of a portion of an example implementation of a wall system 500 according to the present disclosure. Generally, wall system 500 (a portion of which is shown in a plan, sectional view in this figure) can reduce or eliminate external thermal gains while providing internal heating and cooling via a thermal mass of the wall system 500. A core portion of the wall system 500 can include (e.g., embedded) radiant cooling/heating piping that can, in some aspects, serpentine throughout the core portion. In some aspects, the circulation of a thermal fluid (e.g., a cooling fluid or heating fluid) through the piping can be computer controlled to, e.g., 1/10th of a degree Fahrenheit. Such control can reduce or prevent the wall system from reaching a dew point temperature of air adjacent the wall system, as well as under or over shooting set point. In some aspects, the computer control can include forecasting daily temperature and humidity so as not to circulate too much (e.g., flow rate) heating or cooling fluid into the core portion to avoid wide swings in the hysteresis of control.

In some aspects, a corrugated surface is formed or coupled to an interior side of the wall system and can provide for additional surface area for an enhanced heat transfer effect (to or from the wall system). In some aspects, for additional heating and cooling effectiveness, a fan (e.g., a narrow transom fan) can be installed at a top or a bottom of the wall system to increase a convection rate of heat transfer between the wall system and an interior, human-occupiable (or inhabitable) space. The corrugation surface can also, in some aspects, prevent or reduce bad sound harmonics within the interior space (sometimes called the “cave affect”). A frequency and a depth of the corrugated surface can also be tuned to prevent unwanted sound. Within the core portion of the wall system 500, polymers, copper shavings, or other heat transfer compounds can be added to enhance the thermal conductivity of the material of the core portion (this will make a noticeable difference to the thermal management of the structure). In addition, a thickness of the core portion, as well as other structural components of the wall system, can be adjusted to allow for a FEMA rated tornado protection from F-1 to F-5 rating.

Turning to FIG. 5A, the example implementation of the wall system 500 includes a core portion formed, such as cast, from a hardenable material 504, such as concrete, cement, or other material that can be formed into the basis of a wall (load bearing or non-load bearing) of a structure. such as a human-occupiable building. In some aspects, wall system 500 represents an exterior wall of the human-occupiable building. A conduit section 506 (e.g., a length of piping that can hold and circulate a thermal fluid, such as water, glycol, refrigerant, or otherwise) is embedded in the hardenable material 504 of the core portion 502. In this example, and as explained in more detail herein, the conduit section 506 can be a serpentine piping that is fluidly connected to a thermal fluid conditioning system that circulates a thermal fluid through the conduit section 506 so that heat can be transferred between the wall system 500 and an interior space of the human-occupiable building. The thermal fluid can be a cooling fluid, such as a chilled or cooled water flow, such that heat from the interior space is transferred into the cooling fluid. The thermal fluid can be a heating fluid, such as a hot or heated water flow, such that heat from the heating fluid is transferred into the interior space. In this example, the spacing between straight sections of the conduit section 506 (oriented vertically or horizontally with respect to a floor of the building) can be 1 foot on center or as designed by an engineer to provide thermal input to the core portion 502.

In this example implementation, structural supports 508 and 510 can also be positioned (e.g., embedded during casting) within the hardenable material 504 of the core portion 502. For instance, structural supports 508 can be rebar 508 (e.g., #4 rebar) on 1 foot centers or as designed by an engineer to provide a desired FEMA rating for the wall system 500. In addition, structural support 510 can be one or more steel beams that, for instance, can be designed by an engineer to provide a desired FEMA rating for the wall system 500.

As shown in FIG. 5A, the hardenable material 504 can also include one, some, or many heat transfer pieces 516 that are embedded (e.g., during the casting of the core portion 502) in the hardenable material 504. The heat transfer pieces 516 can include or comprise chunks or pieces (regular or irregular in shape) that have a higher thermal conductivity than, for instance, the hardenable material 504. The heat transfer pieces 516 can be, for example, copper, aluminum, steel, or other polymers or compounds that can be embedded within the hardenable material 504 and, for example, increase a thermal mass or conductivity of the core portion 502 relative to an implementation of the core portion 502 that does not include such pieces 516.

In this example, an interior facing surface (e.g., that faces an interior volume of a human-occupiable building) includes a corrugated surface 512. In some aspects, the corrugated surface 512 can be formed or shaped of the hardenable material 504, such as during casting of the hardenable material 504 to form the core portion 502 of the wall system 500. In other aspects, the corrugated surface 512 can be attached (e.g., mechanically, adhesively, or otherwise) to the core portion 502 of the wall system 500. In some aspects, the corrugated surface 512 can be the same material as the hardenable material 504 or can be a different material. As shown, a surface area of the corrugated surface 512 is greater than a surface area of a flat (non-corrugated) surface of the core portion 502, thereby increasing heat transfer between an interior space, through the corrugated surface 512, and the core portion 502 of the wall system 500. As previously described, the corrugated surface 512 can also prevent or reduce bad sound harmonics within the interior space. In some aspects, the “sinusoidal wave” shape of corrugated surface 512 (as shown in FIG. 5A) can be “tuned” (e.g., varied in amplitude or frequency) in order to achieve a particular sound quality within the interior space. As used in the present disclosure, “corrugated” can refer to a surface shaped to resemble or be similar to a sinusoid wave, or any other non-planar surface in which heat transfer is increased relative to a planar surface due to an increase in surface area due to the non-planarity.

As shown in FIG. 5A, one or more thermal sensors 514 (e.g., temperature sensors, humidity sensors, dew point sensors, or a combination thereof) can be positioned at or adjacent the corrugated surface 512 (e.g., within an interior space of the human-occupiable building). In some aspects, the one or more thermal sensors 514 can measure a value of a thermal property of the corrugated surface 512 or the interior space (or both), such as temperature, humidity, dew point, or other property. The measured property can be used, for example, by a control system to control a flow amount or temperature of a thermal fluid through the conduit section 506 to maintain a desired condition at the corrugated surface 512 or in the interior space (or both).

In this example of the wall system 500 and opposite the corrugated surface 512, multiple exterior layers can be coupled to the core portion 502 of the wall system 500. Such layers can, for example, provide insulative or shielding affects (or both), as well as visual enhancement of an exterior surface of the wall system 500 that is exposed to an ambient environment.

For example, layer 518 can be a sealant, such as one or more coats of a sealing paint. In some aspects, the sealant can include a primer paint coat and one or more finish coats of paint. In some aspects, the sealant can include electromagnetic field (EMF) shielding paint.

Next, layer 520 can include an insulation layer that is attached or adhered to the layer 518. In some aspects, this insulation layer can one of several insulation layers that can reduce outdoor thermal and radiant effects from impacting the core portion 502. Layer 520 can be a foil lined closed cell Styrofoam insulation layer. In some aspects, layer 520 can be 1 inch thick with an R-value of 7.

Next, layer 522 can include another insulation layer that is attached or adhered to the layer 520. This layer 522 can provide both thermal insulation and a radiant barrier. For example, layer 522 can include a smart shield insulation. In some aspects, layer 522 can be ⅞ inch thick with an R-value of 23.

Next, layer 524 can include a shielding layer that is attached or adhered to the layer 522. For example, for human-occupiable dwellings or buildings, it may be preferable to limit or prevent microwave and EMI/EMF radiation from entering the interior space. For instance, in the case of a data center or other building that encloses electronic equipment as well as humans or animals, EMI/EMF shielding can be critical. Layer 524 can be a shielding material of a military grade Faraday fabric shield that can stop unwanted radiant effects. In some aspects, layer 524 can be ¼ inch thick. Further, for some uses of the wall system 500, such as military applications, Kevlar can be added to layer 524 to protect the shielding material.

In some aspects, the layer 524 can include one or more Faraday membranes to shield against EMI/EMF radiation and/or geomagnetic storms. In some aspects, such a layer 524 can create a capacitor that surrounds the wall system 500 (and, for example, a building made from wall systems 500) that is grounded (for example, by ground rods installed, e.g., 6 feet and minimum of 10 feet deep in a terranean surface). In some aspects, the places at which the ground rods are installed can be irrigated to insure positive grounding.

Next, layer 526 can include an external finish layer that is attached or adhered to the layer 524. In some aspects, layer 526 can also provide some level of insulation; further, this layer can seal and provide protection to the layers closer to the core portion 502. The external finish layer allows for various methods of enhancing the esthetic value of the building and is only limited by the imagination of the architect. It can be layered, blocked, carved, and sculpted. It can be left blank and flat to be used as a giant canvas for painting by an external building artist.

Turning now to FIG. 5B, a schematic illustration of an elevation view of the wall system 500 is shown. More specifically, FIG. 5B, shows the wall system 500, as well as additional, optional features of the wall system 500 not shown in FIG. 5A. Here, the wall system 500 is shown between a floor 550 and a roof (or ceiling) 552 of a human-occupiable structure. As shown in FIG. 5B, the conduit section 506 (as a vertically-oriented, serpentine conduit) is shown embedded within the wall system 500, with an inlet 528 and an outlet 530. The inlet 528 can be fluidly coupled to a thermal fluid conditioning system to receive a flow of a supply thermal fluid, while the outlet 530 can be fluidly coupled to the thermal fluid conditioning system to return the flow of a supply thermal fluid (now at a different temperature than at the inlet 528 due to heat transfer within the conduit section 506) to the thermal fluid conditioning system.

In some aspects, wall system 500, and potentially an entire building formed from interconnected wall systems 500, may not include any windows or other fenestrations other than doors necessary to enter and exit the building. For example, in some examples, all glass doors and windows can be eliminated in the wall system 500. As shown in FIG. 5B, where traditional windows are desired, a virtual window can be installed in the wall system 500. In this example, a virtual window includes a display 532 communicably coupled through a connection 536 (wired or wireless) to a camera 534 (still or video). The camera 534 can be installed on the outside of the wall system 500 (e.g., to or within layer 526 or otherwise) and wired to the display 532 (e.g., LED, LCD, plasma, or otherwise), which is mounted to or adjacent the corrugated surface 512. The display 532 can be framed to match comparable window framing, thus giving the impression of a window. The display 532 can be used for other purposes such as additional computer monitors when not being used as a virtual window. The camera 534 to the ambient environment (shown on the display 532) can also be utilized for security purposes giving the building 360-degree protection. Careful consideration can be given to properly sealing and shielding the connection 536 (if wired) and its opening to maintain external EMI shielding. For instance, a ¼″ hole can be drilled or sleeved through the wall system 500 to allow for the connection 536.

FIG. 5C shows schematic illustrations of example implementations of forms (or portions thereof) that can be used to construct a core portion of a wall system according to the present disclosure. For example, the example implementations shown in FIG. 5C of forms (or portions of forms) can be used to construct or form a particular shape of the hardenable material 504 of core portion 502 of the wall system 500. FIG. 5C shows example portions of forms in (1), (2), and (3). In some aspects, each form can be made of a polymer (or polymer mixture) in which fiberglass or other added strengthener can be embedded to form a composition. The composition can be extruded (with an extrusion machine) through a particular shape to form the form of that particular shape (with different shapes shown in (1), (2), and (3) of FIG. 5C). In some aspects, an extruded form can be flanged on each edge to allow for connecting (e.g., bolting or otherwise) multiple forms.

Further, in some aspects, flanges can be added to the top and bottom of the finished form to create bow strength. For increased bow strength both vertically and horizontally, in some aspects, steel bracing can be added to the connecting system (e.g., system of bolts). Flat sheets can also be added to allow for carved Styrofoam to be glued to sheet to create images in the hardenable material 504. A number of release agents can be added to the forms as it leaves the extrusion machine and is still warm. The release agent can aid in preventing the hardenable material 504 from sticking to the form. The release agents can range from Teflon, Silicone, oils, or other agents.

In some aspects, such forms can facilitate use of the wall system 500 in commercial and residential environments. A finished form can be cut to any length, round holes or squares can be cut in it to allow for appurtenances, such as electrical boxes or piping. The finished form, once used to shape the hardenable material 504 into a completed core portion 502, can be recycled by simply shredding it and running it back through the extrusion machine. The extrusion machine can be heated with steam and the leaving product can be cooled with a chilled water. The extrusion machine can feed the polymer (or polymer mixture with strengtheners) to an extrusion head or die via a screw drive to create the pressure needed to push the molten polymer through the head. The leaving product can be cooled to allow the form to set.

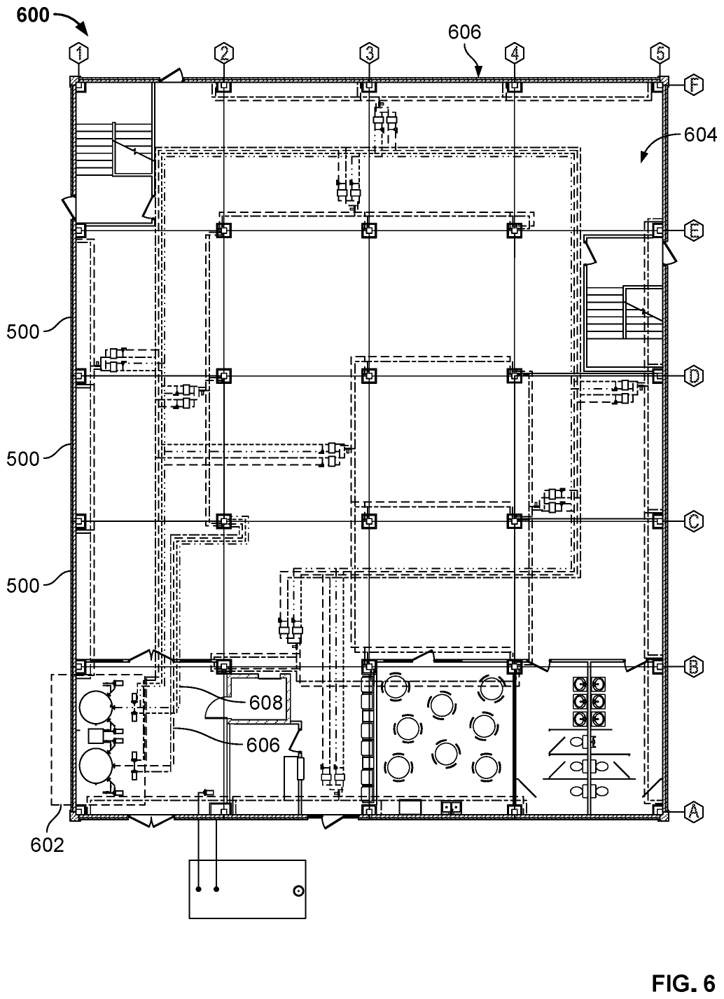

FIG. 6 is a schematic illustration of a human-occupiable environment 600 according to the present disclosure. Generally, in FIG. 6, the human-occupiable environment 600 is represented as a building (in a plan view), which could be a single or multi-story building that can be at least partially constructed with multiple sections of the wall system 500 (as well as utilize a thermal fluid conditioning system as described herein). But human-occupiable environment 600 can represent any enclosed structure (residential or commercial) in which humans can inhabit (live as a primary or secondary residence) or occupy (e.g., for employment purposes or otherwise).

As shown, in this example, the human-occupiable environment 600 is constructed of multiple sections of the wall system 500 that can, for example, provide for most of or all of the exterior structure (exterior wall) of the environment 600. Along with a ceiling or roof (not shown) and a floor, an interior, human-occupiable volume 604 can be defined in the human-occupiable environment 600.

As shown in this example, at least a portion of a thermal fluid conditioning system 602 is included within (or can be exterior to) the human-occupiable environment 600. As explained in more detail herein, a thermal fluid conditioning system, such as thermal fluid conditioning system 602 can include, for example, one or more vapor compression cycle systems, one or more geothermal systems, one or more evaporative cooling systems, or a combination thereof, in order to produce a heated fluid that is circulated through heated fluid piping 608, as well as a cooled fluid that is circulated through cooled fluid piping 606 to the conduit sections of wall systems 500 in order to temperature condition the interior volume 604. In some aspects, electrical power for the thermal fluid conditioning system 602 can be supplied by, for example, off-grid power sources such as solar power, wind power, gas or diesel generators, or a combination thereof (e.g., as part of a system described herein).

In some aspects, an energy system, via solar and microgeneration, can provide electricity for the human-occupiable environment 600 and, more specifically, the thermal fluid conditioning system 602. The energy system can also provide electricity for any outside air units (as described herein), lighting, internal building uses, and electric vehicle charging stations as needed in a parking area.

In addition, the human-occupiable environment 600 that includes the wall systems 500 can realize savings by avoiding some traditional building costs. For example, there may not be an internal wall system as any wall system 500 should be exposed to properly transmit heating or cooling from the thermal mass of the concrete to the room. The most likely scenario is an open building concept although private offices and board rooms can be constructed and conditioned via variable air volume units from a dedicated outdoor air system. As another example, a traditional air conditioning system can be reduced in size and scope by 60% to 75%. This can offset the cost of the distribution and wall piping, pumps, and tanks for the wall systems 500 and thermal fluid conditioning system 602. As another example, there may be no traditional windows in this environment 600; thus, windows can be eliminated from the building budget and the heating and cooling loss calculations. Windows can be virtual windows. As another example, a building that includes wall systems 500 (e.g., that have core portions of a cementitious material such as concrete) can outlast any of its traditional building counterparts. Therefore a lifecycle cost analysis can show that the value of the wall systems 500 (in addition to an energy system as described herein) is greater than that of a traditionally-built building.

As another example, the environment 600 can use solar power to offset most if not all future electric cost from the building, therefore justifying the expense of the solar power system. The combination of the wall systems 500 with the energy system as herein can be a building for the future, both sustainable and durable. Such a combination can easily create a Net-Zero Energy facility and depending on internal use, can even provide energy to spare for neighboring facilities. With proper amounts of battery storage, the environment 600 can also be configured for off-grid.

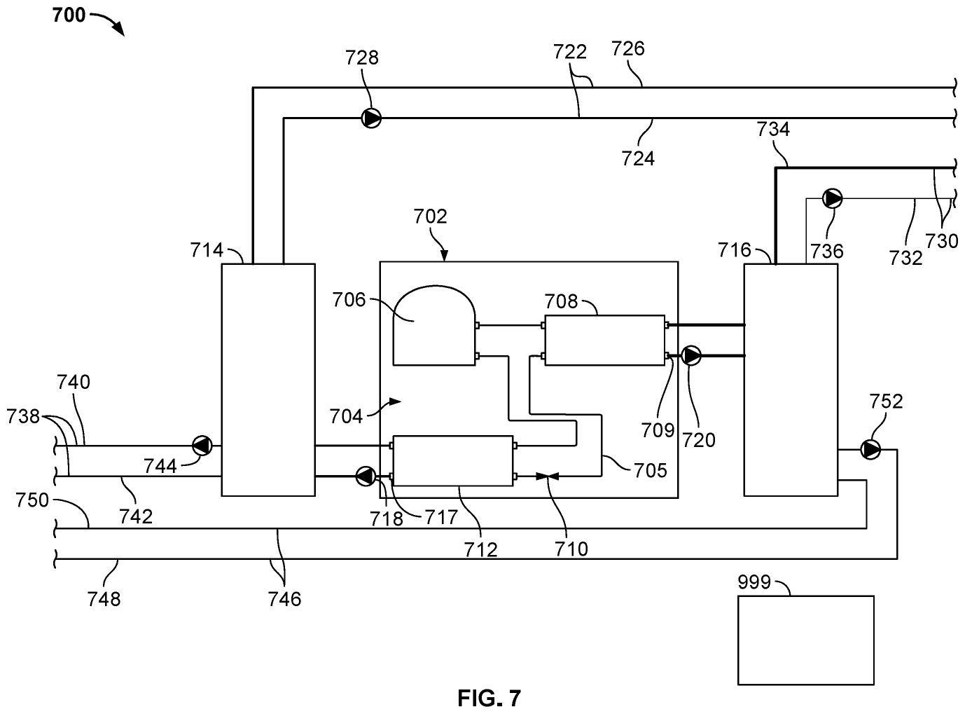

FIG. 7 is a schematic illustration of an example implementation of a portion of a thermal fluid conditioning system 700 for a wall system according to the present disclosure. For example, in some aspects, thermal fluid conditioning system 700 can condition (e.g., adjust a temperature and/or flow rate) a cooling fluid or a heating fluid that is supplied to sections of wall system 500 in a human-occupiable environment (such as environment 600) in order to condition (e.g., adjust a temperature of) an indoor space.

The example implementation of the thermal fluid conditioning system 700 includes one or more fluid apparatus 702. In this example, the fluid apparatus 702 comprises a heat pump 702; however, other forms of fluid apparatus that can condition two or more fluid streams (e.g., a cooling fluid stream and a heating fluid stream, either in series or in parallel operation) are also contemplated by the present disclosure. As shown, the heat pump 702 comprises a vapor compression cycle 704 that includes one or more compressors 706, one or more condenser heat exchangers (“condensers”) 708, one or more expansion devices 710, and one or more evaporator heat exchangers (“evaporators”) 712. A working fluid 705 is circulated within the vapor compression cycle 704 and compressed/expanded in order to transfer heat to a heated fluid 709 within the condenser 708 and receive heat from a cooled fluid 717 in the evaporator 712.

In some aspects, the heat pump 702 can be operated to supply heated fluid 709, or heat from the heated fluid 709, (e.g., at a particular temperature and flow rate) to the conduit section 506 of one or more wall systems 500. In some aspects, the heat pump 702 can be operated to supply cooled fluid 717, or receive heat into the cooled fluid 717, (e.g., at a particular temperature and flow rate) to the conduit section 506 of one or more wall systems 500. The heat pump 702 can be operated to, at any single moment, supply either heated fluid 709 or cooled fluid 717, for example, depending on the indoor environmental conditions of a human-occupiable environment and/or outdoor ambient conditions. In some aspects, a “fluid” can be water, glycol, or other heat transfer liquid.

As shown in this example, the cooling fluid 717 can be circulated by pump 718 to a cooling fluid storage tank 714 (e.g., to store a particular buffer volume of the cooling fluid 717). From the cooling fluid storage tank 714, the cooling fluid 717 can be circulated by pump 728 through a central cooling fluid piping system 722 that includes a cooling fluid supply 724 (that circulates cooling fluid 717 from the cooling fluid storage tank 714 to the wall systems 500) and a cooling fluid return 722 (that circulates cooling fluid 717, at a higher temperature, to the cooling fluid storage tank 714 from the wall systems 500).

The heated fluid 709 can be circulated by pump 720 to a heating fluid storage tank 716 (e.g., to store a particular buffer volume of the heated fluid 709). From the heating fluid storage tank 716, the heated fluid 709 can be circulated by pump 736 through a central heating fluid piping system 730 that includes a heating fluid supply 732 (that circulates heating fluid 709 from the heating fluid storage tank 716 to the wall systems 500) and a heating fluid return 734 (that circulates heating fluid 709, at a lower temperature, to the heating fluid storage tank 716 from the wall systems 500).

In this example implementation of the thermal fluid conditioning system 700, each of the cooling fluid storage tank 714 and the heating fluid storage tank 716 can also be fluidly coupled to respective geothermal piping loops as shown. For example, in some aspects, a geothermal piping loop can be a conduit that extends from a terranean surface into one or more subterranean formations that remain at a relatively constant year round temperature. Depending on latitude, ground temperatures can range from 45° F. (7° C.) to 75° F. (21° C.). This ground temperature is warmer than the air above the terranean surface during the winter and cooler than the air in the summer. The geothermal piping loops, therefore, can circulate a fluid (e.g., water or glycol) into heat transfer contact with the one or more subterranean formations to cool the fluid in a cooling season and heat the fluid in a heating season, respectively. In some aspects, the one or more subterranean formations can be maintained (or helped to be maintained) at a particular temperature by a sprinkler system applied to a terranean surface over the subterranean formation(s) fed by a rainwater collection system (not shown).

For example, as shown, cooling geothermal loop 738 includes a supply 740 that extends form the cooling fluid storage tank 714 into the one or more subterranean formations and a return 742 (that is connected to the supply 740 in a loop) that connects back to the cooling fluid storage tank 714. A pump 744 is positioned to circulate fluid from the tank 714 into the loop 738 in order to cool the fluid by releasing heat from the fluid into the one or more subterranean formations. Thus, in some aspects, if a particular temperature of the fluid in the tank 714 can be met through use of the cooling geothermal loop 738 and not the heat pump 702, “free” cooling can be achieved.

Heating geothermal loop 746 includes a supply 748 that extends form the heating fluid storage tank 716 into the one or more subterranean formations and a return 750 (that is connected to the supply 748 in a loop) that connects back to the heating fluid storage tank 716. A pump 752 is positioned to circulate fluid from the tank 716 into the loop 746 in order to heat the fluid by receiving heat into the fluid from the one or more subterranean formations. Thus, in some aspects, if a particular temperature of the fluid in the tank 716 can be met through use of the heating geothermal loop 746 and not the heat pump 702, “free” heating can be achieved.

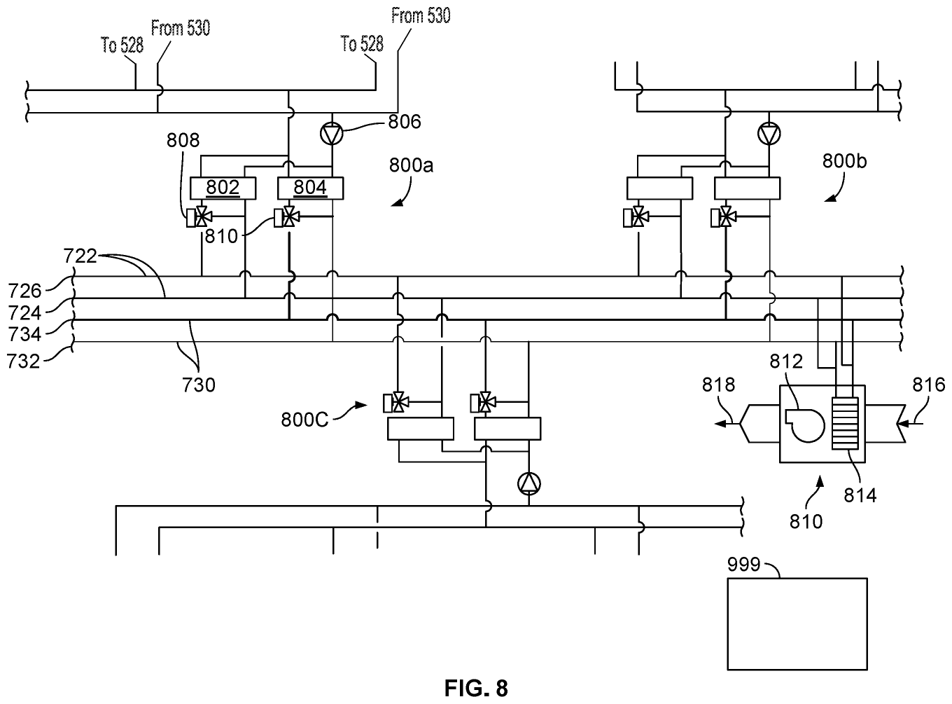

Turning now to FIG. 8, this figure is a schematic illustration of an example implementation of another portion of the thermal fluid conditioning system 700 for a wall system according to the present disclosure. As shown in FIG. 8, the central cooling fluid piping system 722 and the central heating fluid piping system 730 are extended to fluidly couple with thermal fluid sub-assemblies 800a-800c (of which there may be more or fewer depending, e.g., on a number of sections of wall systems 500 that are used to form a human-occupiable environment). Generally, each of thermal fluid sub-assemblies 800a-800c are fluidly and thermally coupled to one or more wall systems 500 in order to provide a cooling or heating fluid to the conduit section 506 of each wall system 500.

As shown in this example implementation, the cooling fluid supply 724 is fluidly connected to a cooling fluid heat exchanger 802 (e.g., a plate and frame or shell and tube heat exchanger), while the cooling fluid return 726 is fluidly connected to the cooling fluid heat exchanger 802, e.g., through a three-way control valve 808. The cooling fluid heat exchanger 802 is, in turn, fluidly and thermally coupled to the inlets 528 and the outlets 530 of the conduit sections 506 of the one or more wall systems 500. Therefore, the cooling fluid 717 can be thermally coupled to the wall systems 500 through each cooling fluid heat exchanger 802. In the case of a call for “cooling” in the wall systems 500, a pump 806 can circulate a fluid from the heat exchanger 802 to the inlets 528 and back from the outlets 530.

The heating fluid supply 732 is fluidly connected to a heating fluid heat exchanger 804 (e.g., a plate and frame or shell and tube heat exchanger), while the heating fluid return 734 is fluidly connected to the heating fluid heat exchanger 804, e.g., through a three-way control valve 811. The heating fluid heat exchanger 804 is, in turn, fluidly and thermally coupled to the inlets 528 and the outlets 530 of the conduit sections 506 of the one or more wall systems 500. Therefore, the heating fluid 709 can be thermally coupled to the wall systems 500 through each heating fluid heat exchanger 804. In the case of a call for “heating” in the wall systems 500, the pump 806 can circulate a fluid from the heat exchanger 804 to the inlets 528 and back from the outlets 530.

As further shown in FIG. 8, the example implementation of the thermal fluid conditioning system 700 can also include one or more dedicated outdoor air units (“OAU”) 810. Generally, each OAU 810 can provide for any additional internal heat gains of the environment, provide for the dilution of carbon dioxide, replenish oxygen, provide for humidity control, and provide for air filtration. Each OAU 810 can supply a flow of outdoor air 816 as a supply airflow 818 (temperature conditioned or not) into an interior space of a human-occupiable environment, e.g., to meet ASHRAE or building codes or otherwise. In this example, the OAU 810 includes one or more fans 812 to circulate the outdoor air 816 into the unit and one or more heat exchanger coils 814 to condition (e.g., heat, cool, dehumidify) the outdoor air 816 to produce the supply airflow 818.

In some aspects, there can be a single heat exchanger coil 814 that is connected to both the central cooling fluid piping system 722 and the central heating fluid piping system 730 to receive either a heating fluid or a cooling fluid depending on the cooling or heating needs of the interior space. In some aspects, the OAU 810 can have a dedicated cooling coil and a dedicated heating coil. In some aspects, the OAU 810 can be a stand-alone unit (for example, a direct expansion packaged or split system) that is not fluidly connected to the central cooling fluid piping system 722 or the central heating fluid piping system 730.

In FIGS. 7 and 8, conditioned fluid streams, such as cooled or chilled water streams, or heated or hot water streams, as well as a working fluid stream in a vapor compression cycle, are circulated (e.g., pumped or naturally circulated through a pressure differential) within the illustrated thermal fluid conditioning system 700. The streams can be flowed using one or more flow control systems 999 (schematically shown) implemented throughout the thermal fluid conditioning system 700. A flow control system can include one or more flow pumps (some shown, some not shown) to pump the streams, one or more flow pipes (or conduits) through which the process streams are flowed and one or more valves (some shown, some not shown) to regulate the flow of streams through the pipes.

In some implementations, the flow control system 999 can be operated manually. For example, an operator can set a flow rate for each pump and set valve open or close positions to regulate the flow of the process streams through the pipes in the flow control system. Once the operator has set the flow rates and the valve open or close positions for all flow control systems distributed across the thermal fluid conditioning system 700, the flow control system 999 can flow the streams under constant flow conditions, for example, constant volumetric rate or such flow conditions. To change the flow conditions, the operator can manually operate the flow control system 999, for example, by changing the pump flow rate or the valve open or close position.

In some implementations, the flow control system 999 can be operated automatically. For example, the flow control system 999 can be connected to a computer system to operate the flow control system. The computer system can include a computer-readable medium storing instructions (such as flow control instructions and other instructions) executable by one or more processors to perform operations (such as flow control operations). An operator can set the flow rates and the valve open or close positions for all flow control systems distributed across the thermal fluid conditioning system 700 using the computer system. In such implementations, the operator can manually change the flow conditions by providing inputs through the computer system. Also, in such implementations, the computer system can automatically (that is, without manual intervention) control one or more of the flow control systems 999, for example, using feedback systems implemented in the thermal fluid conditioning system 700 and connected to the computer system. For example, a sensor (such as a pressure sensor, temperature sensor or other sensor) can be connected to a pipe or conduit through which a stream flows. The sensor can monitor and provide a flow condition (such as a pressure, temperature, or other flow condition) of the stream to the computer system. In response to the flow condition exceeding a threshold (such as a threshold pressure value, a threshold temperature value, or other threshold value), the computer system can automatically perform operations. For example, if the pressure or temperature in the pipe exceeds the threshold pressure value or the threshold temperature value, respectively, the computer system can provide a signal to the pump to decrease a flow rate, a signal to open a valve to relieve the pressure, a signal to shut down process stream flow, or other signals.

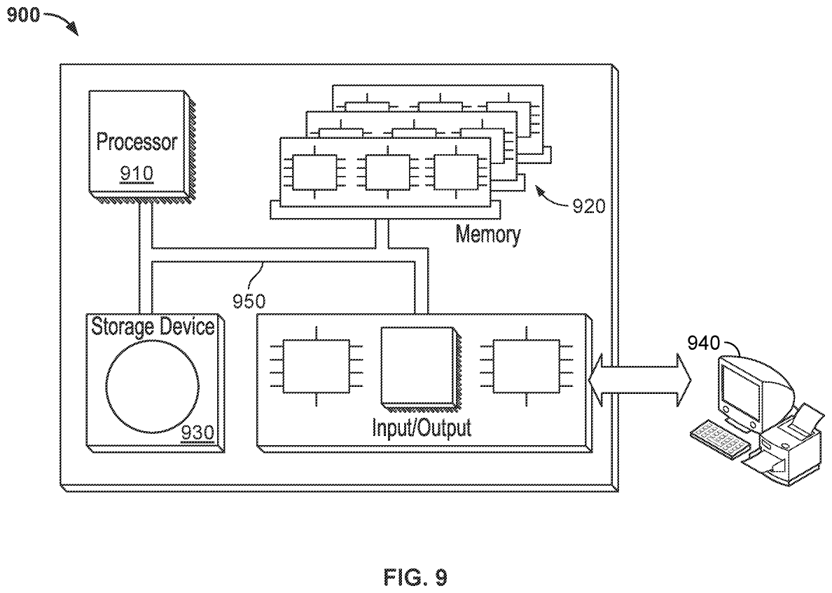

FIG. 9 is a schematic illustration of an example controller 900 (or control system) for a thermal fluid conditioning system or system controller. For example, all or parts of the controller 900 can be used for the operations described previously, for example as or as part of the flow control system 999 or the system controller 120. The controller 900 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 900 includes a processor 910, a memory 920, a storage device 930, and an input/output device 940. Each of the components 910, 920, 930, and 940 are interconnected using a system bus 950. The processor 910 is capable of processing instructions for execution within the controller 900. The processor may be designed using any of a number of architectures. For example, the processor 910 may be a CISC (Complex Instruction Set Computers) processor, a RISC (Reduced Instruction Set Computer) processor, or a MISC (Minimal Instruction Set Computer) processor.

In one implementation, the processor 910 is a single-threaded processor. In another implementation, the processor 910 is a multi-threaded processor. The processor 910 is capable of processing instructions stored in the memory 920 or on the storage device 930 to display graphical information for a user interface on the input/output device 940.

The memory 920 stores information within the controller 900. In one implementation, the memory 920 is a computer-readable medium. In one implementation, the memory 920 is a volatile memory unit. In another implementation, the memory 920 is a non-volatile memory unit.

The storage device 930 is capable of providing mass storage for the controller 900. In one implementation, the storage device 930 is a computer-readable medium. In various different implementations, the storage device 930 may be a floppy disk device, a hard disk device, an optical disk device, a tape device, flash memory, a solid state device (SSD), or a combination thereof.

The input/output device 940 provides input/output operations for the controller 900. In one implementation, the input/output device 940 includes a keyboard and/or pointing device. In another implementation, the input/output device 940 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, solid state drives (SSDs), and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) or LED (light-emitting diode) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

What is claimed is:

1. A power management system comprising:
a power conditioner configured to condition and perform power factor correction on the electrical power supplied to the main circuit;
an inverter, configured to receive direct current (DC) electrical power from a renewable source, and supply alternating current (AC) power to a main circuit that supplies power to an air conditioning system; and
a controller configured to perform operations comprising:
profiling, using a power profiling meter, electrical power supplied to the main circuit; and
modifying operations of the air conditioning system or a battery management system based on the profiled electrical power available.

2. The system of claim 1, wherein the operation of profiling the electrical power comprises detecting voltage, amperage, wattage, total harmonic distortion, electromagnetic interference (EMI), and electromagnetic field (EMF) losses over time.

3. The system of claim 1, wherein the power conditioner filters total harmonic distortion, and applies a variable power factor correction based on sensed apparent power in the main circuit.

4. The system of claim 1, wherein the operation of modifying operations of the air conditioning system comprises one or more of:
activating or deactivating a compressor of the air conditioning system, activating or deactivating one or more economizers of the air conditioning system, adjusting a speed of the compressor, adjusting a thermostat set point, or adjusting an output temperature set point of the air conditioning system.

5. The system of claim 1, wherein the operation of profiling the electrical power comprises logging time series data of voltage, frequency, amperage, real power consumption, apparent power, power factor (PF), and total harmonic distortion (THD).

6. The system of claim 1, wherein the renewable source comprises at least one of a photovoltaic panel or a wind turbine.

7. A method for managing power comprising:
conditioning, with a power conditioner, electrical power supplied to a main circuit supplying power to an air conditioning system, the conditioning comprising performing a power factor correction;
receiving, from an inverter, alternating current (AC) power to the main circuit, the AC power having been converted by the inverter form direct current (DC) power that was generated by a renewable source;
profiling, using a power profiling meter, the electrical power supplied to the main circuit; and
modifying, based on the profiled electrical power, operations of the air conditioning system or a battery management system associated with the main circuit.

8. The method of claim 7, wherein profiling the electrical power comprises detecting voltage, amperage, wattage, total harmonic distortion, electromagnetic interference (EMI), and electromagnetic field (EMF) losses over time.

9. The method of claim 7, wherein the conditioning the electrical power comprises:
filtering total harmonic distortion; and
applying a variable power factor correction based on sensed apparent power in the main circuit.

10. The method of claim 7, wherein modifying operations of the air conditioning system comprises one or more of: activating or deactivating a compressor of the air conditioning system, activating or deactivating one or more economizers of the air conditioning system, adjusting a speed of the compressor, adjusting a thermostat set point, or adjusting an output temperature set point of the air conditioning system.

11. The method of claim 7, wherein profiling the electrical power comprises logging time series data of voltage, frequency, amperage, real power consumption, apparent power, power factor (PF), and total harmonic distortion (THD).

12. The method of claim 7, wherein the renewable source comprises at least one of a photovoltaic panel or a wind turbine.

13. An apparatus comprising a non-transitory, computer readable storage medium that stores instruction that, when executed by at least one processor, cause the at least one processor to perform operations comprising:
conditioning, with a power conditioner, electrical power supplied to a main circuit supplying power to an air conditioning system, the conditioning comprising performing a power factor correction;
receiving, from an inverter, alternating current (AC) power to the main circuit, the AC power having been converted by the inverter form direct current (DC) power that was generated by a renewable source;
profiling, using a power profiling meter, the electrical power supplied to the main circuit; and
modifying, based on the profiled electrical power, operations of the air conditioning system or a battery management system associated with the main circuit.

14. The apparatus of claim 13, wherein the operation of profiling the electrical power comprises detecting voltage, amperage, wattage, total harmonic distortion, electromagnetic interference (EMI), and electromagnetic field (EMF) losses over time.

15. The apparatus of claim 13, wherein the operation of conditioning the electrical power comprises:
filtering total harmonic distortion; and
applying a variable power factor correction based on sensed apparent power in the main circuit.

16. The apparatus of claim 13, wherein modifying operations of the air conditioning system comprises one or more of: activating or deactivating a compressor of the air conditioning system; activating or deactivating one or more economizers of the air conditioning system; adjusting a speed of the compressor; adjusting a thermostat set point; or adjusting an output temperature set point of the air conditioning system.

17. The apparatus of claim 13, wherein the operation of profiling the electrical power comprises logging time series data of voltage, frequency, amperage, real power consumption, apparent power, power factor (PF), and total harmonic distortion (THD).

18. The apparatus of claim 13, wherein the renewable source comprises at least one of a photovoltaic panel or a wind turbine.

19. An air conditioning system, comprising:
an irradiance sensor configured to detect an ambient solar irradiance;
a renewable meter configured to detect a power amount generated by a renewable source;
an inverter meter configured to detect a power output of an inverter associated with the renewable source;
an array of air conditioning sensors configured to detect: a differential pressure across a fan associated with the air conditioner, an ambient humidity, an ambient temperature, a supply humidity, a supply temperature, a return humidity, a return temperature, and a power consumption associated with the air conditioner;
a controller configured to determine a plurality of parameters comprising: a supply enthalpy based on the supply humidity and supply temperature, a return enthalpy based on the return humidity and return temperature, an ambient enthalpy based on the ambient humidity and ambient temperature, an airflow rate based on the differential pressure across the fan, an inverter efficiency based on the power output of the inverter, and the power amount generated by the renewable source, a solar efficiency based on the ambient solar irradiance and the power amount generated by the renewable source, and an air conditioner efficiency based on the airflow rate, the supply enthalpy, and the return enthalpy.

20. The system of claim 19, wherein the controller is configured to transmit an alert if a particular parameter of the plurality of parameters falls within a predetermined threshold.

21. The system of claim 19, wherein in response to ambient enthalpy being less than return enthalpy the controller sends a signal to activate an economizer in the air conditioner.

22. The system of claim 20, wherein in response to air conditioner efficiency falling within the predetermined threshold the alert indicates that a system inspection is required.

23. The system of claim 22, wherein in response to the airflow rate falling within the predetermined threshold the alert indicates a filter replacement is required.

24. The system of claim 22, wherein in response to the difference between the return enthalpy and the supply enthalpy falling within the predetermined threshold, the alert indicates that a heat exchanger inspection is required.

25. The system of claim 20, wherein in response to the solar efficiency falling within the predetermined threshold, the alert indicates a panel inspection is required.

26. The system of claim 20, wherein, in response to inverter efficiency falling within the predetermined threshold, the alert indicates inverter inspection or replacement is required.

27. A method for monitoring an air conditioning system, the method comprising:
detecting, with an irradiance sensor, an ambient solar irradiance;
detecting, with a renewable meter, a power amount generated by a renewable source;
detecting, with an inverter meter, a power output of an inverter associated with the renewable source;
detecting, with an array of air conditioning sensors, a differential pressure across a fan associated with the air conditioner, an ambient humidity, an ambient temperature, a supply humidity, a supply temperature, a return humidity, a return temperature, and a power consumption associated with the air conditioner; and
determining, using a controller, a plurality of parameters comprising: a supply enthalpy based on the supply humidity and supply temperature, a return enthalpy based on the return humidity and return temperature, an ambient enthalpy based on the ambient humidity and ambient temperature, an airflow rate based on the differential pressure across the fan, an inverter efficiency based on the power output of the inverter, and the power amount generated by the renewable source, a solar efficiency based on the ambient solar irradiance and the power amount generated by the renewable source, and an air conditioner efficiency based on the airflow rate, the supply enthalpy, and the return enthalpy.

28. The method of claim 27, comprising transmitting an alert if a particular parameter of the plurality of parameters falls within a predetermined threshold.

29. The method of claim 27, wherein in response to ambient enthalpy being less than return enthalpy the controller sends a signal to activate an economizer in the air conditioner.

30. The method of claim 28, wherein in response to air conditioner efficiency falling within the predetermined threshold the alert indicates that a system inspection is required.

31. The method of claim 30, wherein in response to the airflow rate falling within the predetermined threshold the alert indicates a filter replacement is required.

32. The method of claim 30, wherein in response to the difference between the return enthalpy and the supply enthalpy falling within the predetermined threshold, the alert indicates that a heat exchanger inspection is required.

33. The method of claim 28, wherein in response to the solar efficiency falling within the predetermined threshold, the alert indicates a panel inspection is required.

34. The method of claim 28, wherein, in response to inverter efficiency falling within the predetermined threshold, the alert indicates inverter inspection or replacement is required.

35. An apparatus comprising a non-transitory, computer readable storage medium that stores instruction that, when executed by at least one processor, cause the at least one processor to perform operations comprising:
detecting, with an irradiance sensor, an ambient solar irradiance;
detecting, with a renewable meter, a power amount generated by a renewable source;
detecting, with an inverter meter, a power output of an inverter associated with the renewable source;
detecting, with an array of air conditioning sensors, a differential pressure across a fan associated with the air conditioner, an ambient humidity, an ambient temperature, a supply humidity, a supply temperature, a return humidity, a return temperature, and a power consumption associated with the air conditioner; and
determining, using a controller, a plurality of parameters comprising: a supply enthalpy based on the supply humidity and supply temperature, a return enthalpy based on the return humidity and return temperature, an ambient enthalpy based on the ambient humidity and ambient temperature, an airflow rate based on the differential pressure across the fan, an inverter efficiency based on the power output of the inverter and the power amount generated by the renewable source, a solar efficiency based on the ambient solar irradiance and the power amount generated by the renewable source, and an air conditioner efficiency based on the airflow rate, the supply enthalpy, and the return enthalpy.

36. The apparatus of claim 35, comprising transmitting an alert if a particular parameter of the plurality of parameters falls within a predetermined threshold.

37. The apparatus of claim 35, wherein in response to ambient enthalpy being less than return enthalpy the controller sends a signal to activate an economizer in the air conditioner.

38. The apparatus of claim 36, wherein in response to air conditioner efficiency falling within the predetermined threshold the alert indicates that a system inspection is required.

39. The apparatus of claim 38, wherein in response to the airflow rate falling within the predetermined threshold the alert indicates a filter replacement is required.

40. The apparatus of claim 38, wherein in response to the difference between the return enthalpy and the supply enthalpy falling within the predetermined threshold, the alert indicates that a heat exchanger inspection is required.

41. The apparatus of claim 36, wherein in response to the solar efficiency falling within the predetermined threshold, the alert indicates a panel inspection is required.

42. The apparatus of claim 36, wherein, in response to inverter efficiency falling within the predetermined threshold, the alert indicates inverter inspection or replacement is required.
